(19) United States
(12) Patent Application Publication
(10) Pub. No.: US 2024/0276275 A1
(43) Pub. Date: Aug. 15, 2024

(54) SELF-ORGANIZING NETWORK OR MINIMIZATION OF DRIVE TEST DATA COLLECTION FOR SMALL DATA

(71) Applicant: QUALCOMM Incorporated, San Diego, CA (US)

(72) Inventors: Rajeev KUMAR, San Diego, CA (US); Ruiming ZHENG, Beijing (CN); Gavin Bernard HORN, La Jolla, CA (US); Xipeng ZHU, San Diego, CA (US); Aziz GHOLMIEH, Del Mar, CA (US); Shankar KRISHNAN, San Diego, CA (US)

(21) Appl. No.: 18/569,462

(22) PCT Filed: Aug. 27, 2021
(86) PCT No.: PCT/CN2021/115028

§ 371 Date: Dec. 12, 2023

(51) Int. Cl. H04W 24/10; H04W 74/0833

(52) U.S. Cl. CPC H04W 24/10; H04W 74/0833

(57) ABSTRACT

Methods, systems, and devices for wireless communications are described. A user equipment (UE) may transmit an uplink data message to a base station while the UE is in an inactive mode with respect to the base station. The UE may transmit the uplink data message in accordance with a communications procedure, which may be an example of a random access channel (RACH)-based communications procedure or a configured grant (CG)-based communications procedure. The UE may generate a report that includes parameters related to transmission of the uplink data message, which may be used to improve subsequent uplink data message transmissions from the UE, subsequent RACH procedures performed by the UE, or both. The UE may determine which parameters to include in the report based on the communications procedure and whether transmission of the uplink data message was successful. Accordingly, the UE may transmit the report to the base station.

### CROSS REFERENCE

The present Application is a 371 national stage filing of International PCT Application No. PCT/CN2021/115028 by KUMAR et al. entitled “SELF-ORGANIZING NETWORK OR MINIMIZATION OF DRIVE TEST DATA COLLECTION FOR SMALL DATA,” filed Aug. 27, 2021, which is assigned to the assignee hereof, and which is expressly incorporated by reference in its entirety herein.

### FIELD OF TECHNOLOGY

The following relates to wireless communications, including self-organizing network (SON) or minimization of drive test (MDT) data collection for small data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may attempt to transmit an uplink data message to a base station while the UE is in an inactive state. If the attempt is unsuccessful, the UE may be unable to provide the base station with information related to the unsuccessful attempt. For example, the UE may be unable to provide the base station with statistics or measurements related to radio quality, data volume, throughput, packet delay, or packet loss, among other examples. Thus, the base station may be unable to use this information to increase the likelihood that subsequent uplink data message transmissions from the UE are successful. As a result, the base station may be unable to provide any quality of service (QOS) guarantees for data that is transmitted from an inactive state.

### SUMMARY

The described techniques relate to improved methods, systems, devices, and apparatuses that support self-organizing network (SON) or minimization of drive test (MDT) data collection for small data. Generally, the described techniques provide for configuring a user equipment (UE) to report SON or MDT data for the purpose of improving small data transmissions (SDTs) from the UE. In accordance with the described techniques, a UE may transmit an uplink data message (e.g., an SDT) to a base station while the UE is in an inactive mode with respect to the base station. The UE may transmit the uplink data message in accordance with a communications procedure, which may be an example of a random access channel (RACH)-based communications procedure or a configured grant (CG)-based communications procedure. The UE may generate a report that includes various parameters related to transmission of the uplink data message, which the base station may use to improve subsequent uplink data message transmissions from the UE, subsequent RACH procedures performed by the UE, or both. The UE may determine which parameters to include in the report based on the communications procedure and on whether transmission of the uplink data message was successful. Accordingly, the UE may transmit the report to the base station.

A method for wireless communications at a UE is described. The method may include transmitting, in accordance with a communications procedure, an uplink data message to a base station while the UE is in an inactive mode with respect to communications with the base station, generating a report that includes one or more parameters pertaining to uplink data message transmission to the base station, where the one or more parameters included in the report are based on the communications procedure associated with the uplink data message and on whether transmission of the uplink data message to the base station was successful, and transmitting the report to the base station.

An apparatus for wireless communications at a UE is described. The apparatus may include a processor, memory coupled with the processor, and instructions stored in the memory. The instructions may be executable by the processor to cause the apparatus to transmit, in accordance with a communications procedure, an uplink data message to a base station while the UE is in an inactive mode with respect to communications with the base station, generate a report that includes one or more parameters pertaining to uplink data message transmission to the base station, where the one or more parameters included in the report are based on the communications procedure associated with the uplink data message and on whether transmission of the uplink data message to the base station was successful, and transmit the report to the base station.

Another apparatus for wireless communications at a UE is described. The apparatus may include means for transmitting, in accordance with a communications procedure, an uplink data message to a base station while the UE is in an inactive mode with respect to communications with the base station, means for generating a report that includes one or more parameters pertaining to uplink data message transmission to the base station, where the one or more parameters included in the report are based on the communications procedure associated with the uplink data message and on whether transmission of the uplink data message to the base station was successful, and means for transmitting the report to the base station.

A non-transitory computer-readable medium storing code for wireless communications at a UE is described. The code may include instructions executable by a processor to transmit, in accordance with a communications procedure, an uplink data message to a base station while the UE is in an inactive mode with respect to communications with the base station, generate a report that includes one or more parameters pertaining to uplink data message transmission to the base station, where the one or more parameters included in the report are based on the communications procedure associated with the uplink data message and on whether transmission of the uplink data message to the base station was successful, and transmit the report to the base station.

In some examples of the method, apparatuses, and non-transitory computer-readable medium described herein, transmitting the report may include operations, features, means, or instructions for transmitting the report to the base station for enhancement of subsequent uplink data message transmissions from the UE, improvement of random access procedures and resources used for subsequent uplink data message transmissions from the UE, or both.

In some examples of the method, apparatuses, and non-transitory computer-readable medium described herein, transmitting the uplink data message may include operations, features, means, or instructions for receiving, from the base station, a CG indicating one or more physical uplink shared channel (PUSCH) resources and transmitting the uplink data message to the base station on the one or more PUSCH resources in accordance with the CG, where the communications procedure is the CG.

In some examples of the method, apparatuses, and non-transitory computer-readable medium described herein, transmitting the uplink data message may include operations, features, means, or instructions for transmitting the uplink data message to the base station on a RACH in accordance with a random access procedure, where the communications procedure is the random access procedure.

In some examples of the method, apparatuses, and non-transitory computer-readable medium described herein, transmitting the uplink data message on the RACH may include operations, features, means, or instructions for transmitting the uplink data message via the RACH based on a prior attempt to transmit the uplink data message to the base station in accordance with a CG being unsuccessful.

In some examples of the method, apparatuses, and non-transitory computer-readable medium described herein, generating the report may include operations, features, means, or instructions for generating a random access report based on successful transmission of the uplink data message on the RACH, where the one or more parameters included in the random access report include a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a RACH fallback procedure during transmission of the uplink data message, or a combination thereof.

In some examples of the method, apparatuses, and non-transitory computer-readable medium described herein, generating the random access report may include operations, features, means, or instructions for generating the random access report based on successful transmission of the uplink data message on the RACH, where the one or more parameters included in the random access report include data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, non-access stratum (NAS) event-triggering information related to the communications procedure, timing information related to the uplink data message, or a combination thereof.

In some examples of the method, apparatuses, and non-transitory computer-readable medium described herein, generating the random access report may include operations, features, means, or instructions for logging the one or more parameters of the random access report until a connection release message or a connection resume message may be received from the base station.

In some examples of the method, apparatuses, and non-transitory computer-readable medium described herein, generating the report may include operations, features, means, or instructions for generating a logged MDT report or an SDT report based on successful transmission of the uplink data message on the RACH.

Some examples of the method, apparatuses, and non-transitory computer-readable medium described herein may further include operations, features, means, or instructions for determining that transmission of the uplink data message on the RACH was unsuccessful based on a failure of the random access procedure, expiration of a timer related to a failure status of the uplink data message, detection of an integrity check failure at the UE, or a combination thereof.

In some examples of the method, apparatuses, and non-transitory computer-readable medium described herein, generating the report may include operations, features, means, or instructions for generating a connection establishment failure (CEF) report, a logged MDT report, or an SDT report based on failure of the transmission of the uplink data message on the RACH.

In some examples of the method, apparatuses, and non-transitory computer-readable medium described herein, generating the report may include operations, features, means, or instructions for generating a CEF report based on determining that the transmission of the uplink data message on the RACH was unsuccessful, where the CEF report includes a set of random access parameters used for transmission of the uplink data message, a set of channel measurements related to transmission of the uplink data message, data volume information pertaining to the UE, payload information associated with the uplink data message, data arrival information related to transmission of the uplink data message, or a combination thereof.

In some examples of the method, apparatuses, and non-transitory computer-readable medium described herein, generating the report may include operations, features, means, or instructions for generating a logged MDT report or an SDT report based on the communications procedure being a CG or on the communications procedure being a successful random access procedure, where the one or more parameters of the logged MDT report or the SDT report include an SDT type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, CG resource release information associated with the communications procedure, an indication of whether the UE has switched communications procedures during transmission of the uplink data message, cell reselection information related to the communications procedure, an indication of CG resources or dynamic grant (DG) resources used for transmission of the uplink data message, QoS metrics associated with transmission of the uplink data message, or a combination thereof.

In some examples of the method, apparatuses, and non-transitory computer-readable medium described herein, generating the report may include operations, features, means, or instructions for determining that a timer related to a failure status of the uplink data message has not expired and generating a logged MDT report or an SDT report based on determining that the timer has not expired, where the one or more parameters of the logged MDT report or the SDT report include an SDT type used for transmission of the uplink data message, event-based logging information related to transmission of the uplink data message, a set of channel measurements associated with transmission of the uplink data message, traffic pattern information related to the uplink data message, retransmission information associated with the uplink data message, data arrival information related to the uplink data message, radio bearer information related to the uplink data message, timing information associated with transmission of the uplink data message, NAS event-triggering information pertaining to the communications procedure, network transmission type switching information associated with the communications procedure, or a combination thereof.

In some examples of the method, apparatuses, and non-transitory computer-readable medium described herein, generating the report may include operations, features, means, or instructions for determining that a timer related to a failure status of the uplink data message has expired and generating a logged MDT report or an SDT report based on determining that the timer has expired, where the one or more parameters of the logged MDT report or the SDT report include an SDT type used for transmission of the uplink data message, a set of channel measurements associated with transmission of the uplink data message, payload information related to the uplink data message, data volume information pertaining to the UE, event-based logging information related to transmission of the uplink data message, CG resource release information associated with the communications procedure, an indication of whether the UE has switched communications procedures during transmission of the uplink data message, cell reselection information related to the communications procedure, or a combination thereof.

In some examples of the method, apparatuses, and non-transitory computer-readable medium described herein, transmitting the uplink data message may include operations, features, means, or instructions for transmitting an SDT message as the uplink data message while the UE may be in the inactive mode based on the uplink data message having a payload size that may be below a preconfigured threshold.

In some examples of the method, apparatuses, and non-transitory computer-readable medium described herein, generating the report may include operations, features, means, or instructions for generating the report based on transmitting the uplink data message in an unlicensed radio frequency (RF) spectrum band, where the one or more parameters of the report include bandwidth part (BWP) information related to transmission of the uplink data message, listen before talk (LBT) failure information associated with transmission of the uplink data message, a failure status of the uplink data message, or a combination thereof.

In some examples of the method, apparatuses, and non-transitory computer-readable medium described herein, transmitting the report may include operations, features, means, or instructions for transmitting the report to the base station while the UE may be in a connected mode or an inactive mode with respect to communications with the base station.

Some examples of the method, apparatuses, and non-transitory computer-readable medium described herein may further include operations, features, means, or instructions for transmitting, to the base station, a capability message indicating a capability of the UE to generate SON or MDT reporting information for SDTs and receiving, from the base station and based on the capability message, control signaling that indicates a set of SON or MDT reporting criteria, where generating the report may be based on the set of SON or MDT reporting criteria.

Some examples of the method, apparatuses, and non-transitory computer-readable medium described herein may further include operations, features, means, or instructions for transmitting, to the base station and based on generating the report, an indication that the report is available for transmission.

Some examples of the method, apparatuses, and non-transitory computer-readable medium described herein may further include operations, features, means, or instructions for receiving, from the base station and in response to the indication, a request for the UE to transmit the report, where transmitting the report may be based on receiving the request.

Some examples of the method, apparatuses, and non-transitory computer-readable medium described herein may further include operations, features, means, or instructions for transmitting the uplink data message, the report, an indication that the report is available for transmission, or a combination thereof via one or more signaling radio bearers (SRBs) or dedicated radio bearers (DRBs).

A method for wireless communications at a base station is described. The method may include transmitting, to a UE, control signaling that indicates a set of SON or MDT reporting criteria and receiving a report from the UE in accordance with the set of SON or MDT reporting criteria, where the report includes one or more parameters pertaining to an attempt by the UE to transmit an uplink data message to the base station while the UE is in an inactive mode with respect to communications with the base station, and where the one or more parameters included in the report are based on a communications procedure associated with the uplink data message and on whether transmission of the uplink data message to the base station was successful.

An apparatus for wireless communications at a base station is described. The apparatus may include a processor, memory coupled with the processor, and instructions stored in the memory. The instructions may be executable by the processor to cause the apparatus to transmit, to a UE, control signaling that indicates a set of SON or MDT reporting criteria, and receive a report from the UE in accordance with the set of SON or MDT reporting criteria, where the report includes one or more parameters pertaining to an attempt by the UE to transmit an uplink data message to the base station while the UE is in an inactive mode with respect to communications with the base station, and where the one or more parameters included in the report are based on a communications procedure associated with the uplink data message and on whether transmission of the uplink data message to the base station was successful.

Another apparatus for wireless communications at a base station is described. The apparatus may include means for transmitting, to a UE, control signaling that indicates a set of SON or MDT reporting criteria, and means for receiving a report from the UE in accordance with the set of SON or MDT reporting criteria, where the report includes one or more parameters pertaining to an attempt by the UE to transmit an uplink data message to the base station while the UE is in an inactive mode with respect to communications with the base station, and where the one or more parameters included in the report are based on a communications procedure associated with the uplink data message and on whether transmission of the uplink data message to the base station was successful.

A non-transitory computer-readable medium storing code for wireless communications at a base station is described. The code may include instructions executable by a processor to transmit, to a UE, control signaling that indicates a set of SON or MDT reporting criteria, and receive a report from the UE in accordance with the set of SON or MDT reporting criteria, where the report includes one or more parameters pertaining to an attempt by the UE to transmit an uplink data message to the base station while the UE is in an inactive mode with respect to communications with the base station, and where the one or more parameters included in the report are based on a communications procedure associated with the uplink data message and on whether transmission of the uplink data message to the base station was successful.

In some examples of the method, apparatuses, and non-transitory computer-readable medium described herein, receiving the report may include operations, features, means, or instructions for receiving the report from the UE for enhancement of subsequent uplink data message transmissions from the UE, improvement of random access procedures and resources used for subsequent uplink data message transmissions from the UE, or both.

Some examples of the method, apparatuses, and non-transitory computer-readable medium described herein may further include operations, features, means, or instructions for transmitting, to a serving base station of the UE, an indication of the report, an indication of a MDT configuration pertaining to the UE, or both.

In some examples of the method, apparatuses, and non-transitory computer-readable medium described herein, the base station may be an anchor base station for the UE or a serving base station of the UE.

Some examples of the method, apparatuses, and non-transitory computer-readable medium described herein may further include operations, features, means, or instructions for performing a QoS verification procedure based on receiving the report from the UE.

Some examples of the method, apparatuses, and non-transitory computer-readable medium described herein may further include operations, features, means, or instructions for transmitting, to the UE, a CG indicating one or more PUSCH resources and receiving the uplink data message from the UE on the one or more PUSCH resources in accordance with the CG, where the communications procedure is the CG.

Some examples of the method, apparatuses, and non-transitory computer-readable medium described herein may further include operations, features, means, or instructions for receiving the uplink data message from the UE on a RACH in accordance with a random access procedure, where the communications procedure is the random access procedure.

Some examples of the method, apparatuses, and non-transitory computer-readable medium described herein may further include operations, features, means, or instructions for generating a set of measurements related to the random access procedure, where the set of measurements includes a time difference between reception of a random access message and transmission of downlink data, a time difference between reception of the random access message and transmission of a second random access message, a payload size of the random access message, a payload size of the second random access message, or a combination thereof.

In some examples of the method, apparatuses, and non-transitory computer-readable medium described herein, receiving the report may include operations, features, means, or instructions for receiving a random access report from the UE based on successful reception of the uplink data message on the RACH, where the one or more parameters included in the random access report include a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a RACH fallback procedure during transmission of the uplink data message, or a combination thereof.

In some examples of the method, apparatuses, and non-transitory computer-readable medium described herein, receiving the random access report may include operations, features, means, or instructions for receiving the random access report from the UE based on successful reception of the uplink data message on the RACH, where the one or more parameters included in the random access report include data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, NAS event-triggering information associated with the communications procedure, timing information related to the uplink data message, or a combination thereof.

In some examples of the method, apparatuses, and non-transitory computer-readable medium described herein, receiving the report may include operations, features, means, or instructions for receiving a CEF report, a logged MDT report, or an SDT report from the UE based on unsuccessful reception of the uplink data message.

In some examples of the method, apparatuses, and non-transitory computer-readable medium described herein, receiving the report may include operations, features, means, or instructions for receiving a random access report, a logged MDT report, or an SDT report from the UE based on successful reception of the uplink data message.

In some examples of the method, apparatuses, and non-transitory computer-readable medium described herein, receiving the report may include operations, features, means, or instructions for receiving a CEF report from the UE based on unsuccessful reception of the uplink data message on a RACH, where the one or more parameters included in the CEF report include a set of random access parameters related to the uplink data message, a set of channel measurements related to transmission of the uplink data message, data volume information pertaining to the UE, payload information associated with the uplink data message, data arrival information related to the uplink data message, or a combination thereof.

In some examples of the method, apparatuses, and non-transitory computer-readable medium described herein, receiving the report may include operations, features, means, or instructions for receiving a logged MDT report or an SDT report based on the communications procedure being a CG or on the communications procedure being a successful random access procedure, where the one or more parameters of the logged MDT report or the SDT report include an SDT type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, CG resource release information associated with the communications procedure, an indication of whether the UE has switched communications procedures during transmission of the uplink data message, cell reselection information related to the communications procedure, an indication of CG resources or DG resources used for transmission of the uplink data message, QoS metrics associated with transmission of the uplink data message, or a combination thereof.

Some examples of the method, apparatuses, and non-transitory computer-readable medium described herein may further include operations, features, means, or instructions for receiving an SDT message as the uplink data message while the UE may be in the inactive mode based on the uplink data message having a payload size that may be below a preconfigured threshold.

In some examples of the method, apparatuses, and non-transitory computer-readable medium described herein, receiving the report may include operations, features, means, or instructions for receiving the report based on an attempt by the UE to transmit the uplink data message in an unlicensed RF spectrum band, where the one or more parameters of the report include BWP information related to transmission of the uplink data message, LBT failure information associated with transmission of the uplink data message, a failure status of the uplink data message, or a combination thereof.

In some examples of the method, apparatuses, and non-transitory computer-readable medium described herein, receiving the report may include operations, features, means, or instructions for receiving the report from the UE while the UE may be in a connected mode or an inactive mode with respect to communications with the base station.

Some examples of the method, apparatuses, and non-transitory computer-readable medium described herein may further include operations, features, means, or instructions for receiving, from the UE, a capability message indicating a capability of the UE to generate SON or MDT reporting information for SDTs, where transmitting the control signaling to the UE may be based on the capability message.

Some examples of the method, apparatuses, and non-transitory computer-readable medium described herein may further include operations, features, means, or instructions for transmitting a request for the report to the UE, where receiving the report from the UE may be based on the request.

Some examples of the method, apparatuses, and non-transitory computer-readable medium described herein may further include operations, features, means, or instructions for receiving, from the UE, an indication that the report is available for transmission, where transmitting the request may be based on receiving the indication.

Some examples of the method, apparatuses, and non-transitory computer-readable medium described herein may further include operations, features, means, or instructions for receiving the uplink data message, the report, an indication that the report is available for transmission, or a combination thereof via one or more SRBs or DRBs in accordance with the set of SON or MDT reporting criteria.

### BRIEF DESCRIPTION OF THE DRAWINGS

FIGS. 1 and 2 illustrate examples of wireless communications systems that support self-organizing network (SON) or minimization of drive test (MDT) data collection for small data in accordance with aspects of the present disclosure.

FIG. 3 illustrates an example of a process flow that supports SON or MDT data collection for small data in accordance with aspects of the present disclosure.

FIGS. 4 and 5 show block diagrams of devices that support SON or MDT data collection for small data in accordance with aspects of the present disclosure.

FIG. 6 shows a block diagram of a communications manager that supports SON or MDT data collection for small data in accordance with aspects of the present disclosure.

FIG. 7 shows a diagram of a system including a device that supports SON or MDT data collection for small data in accordance with aspects of the present disclosure.

FIGS. 8 and 9 show block diagrams of devices that support SON or MDT data collection for small data in accordance with aspects of the present disclosure.

FIG. 10 shows a block diagram of a communications manager that supports SON or MDT data collection for small data in accordance with aspects of the present disclosure.

FIG. 11 shows a diagram of a system including a device that supports SON or MDT data collection for small data in accordance with aspects of the present disclosure.

FIGS. 12 through 15 show flowcharts illustrating methods that support SON or MDT data collection for small data in accordance with aspects of the present disclosure.

### DETAILED DESCRIPTION

In some wireless communications systems, a user equipment (UE) may transmit an uplink data message to a base station while the UE is in an inactive state. The uplink data message, which may be equivalently referred to herein as a small data transmission (SDT), may have a payload size that is below a preconfigured threshold. In some cases, the UE may transmit an SDT using a random access channel (RACH)-based scheme or a configured grant (CG)-based scheme. In a RACH-based scheme, the UE may transmit an SDT in a payload portion of a RACH message (e.g., msgA or msg3). In a CG-based scheme, the UE may receive a CG indicating a set of physical uplink shared channel (PUSCH) resources, and may transmit an SDT on the PUSCH resources in accordance with the CG.

In some cases, however, the UE may determine that an SDT is unsuccessful. For example, the UE may determine that a timer associated with an SDT has expired or that an integrity check failure has occurred while the timer is running. In such cases, the UE may unable to provide the base station with information related to the unsuccessful SDT, which may reduce the reliability of subsequent communications between the UE and the base station. That is, the base station may be unable to use information provided by the UE to improve subsequent SDTs from the UE.

In accordance with aspects of the present disclosure, the UE may be configured to report self-organizing network (SON) or minimization of drive test (MDT) data related to the SDT. The base station may use the SON or MDT data reported by the UE to improve the likelihood of successful communications between the base station and the UE. For example, the base station may adjust one or more network configuration parameters (e.g., transmission parameters, resource allocations, modulation schemes) to improve the likelihood that subsequent SDTs from the UE are successful. In some examples, the base station may configure the UE with a set of SON or MDT reporting criteria, and the UE may generate (e.g., log, record) information related to an SDT in accordance with the set of SON or MDT reporting criteria. Specifically, the UE may generate a SON or MDT report that includes various information elements (IEs) related to an SDT, and may transmit the SON or MDT report to the base station in accordance with the set of SON or MDT reporting criteria.

The SON or MDT report may include a random access report (e.g., a RACH report), a connection establishment failure (CEF) report, a logged MDT report, or an SDT report, among other examples. If, for example, the UE determines that an SDT is successful, the UE may generate a random access report, a logged MDT report, or an SDT report that includes SON or MDT data related to the SDT. Alternatively, if the UE determines that an SDT is unsuccessful, the UE may generate a CEF report, a logged MDT report, or an SDT report that includes SON or MDT data related to the SDT. Accordingly, the UE may transmit the SON or MDT report to the base station such that the base station can use the SDT-related SON or MDT data to improve the likelihood of successful SDTs from the UE.

In some examples, a serving base station and an anchor base station for the UE may obtain MDT measurements from the UE. The MDT measurements may include data volume measurements, throughput measurements, packet delay measurements, and packet loss measurements for packets (e.g., uplink data) transmitted by the UE while the UE is in an inactive state. Accordingly, the serving base station and the anchor base station may use the MDT measurements to perform quality of service (QOS) verification. In some examples, the serving base station and the anchor base station may extend a connected state MDT framework to an inactive state for QoS verification.

Aspects of the present disclosure may be implemented to realize one or more of the following advantages. The described techniques may provide for using SDT-related SON or MDT data to improve the reliability of SDTs from the UE. For example, the described techniques may enable the UE to transmit a SON or MDT report that includes various IEs (e.g., channel measurements, RACH parameters, failure information) related to an SDT. Accordingly, the base station may receive the SON or MDT report, and may adjust one or more network configuration parameters (e.g., RACH parameters, resource allocations, transmission parameters, modulation schemes) to improve the likelihood of the base station successfully receiving subsequent SDTs from the UE.

Aspects of the disclosure are initially described in the context of wireless communications systems and process flows. Aspects of the disclosure are further illustrated by and described with reference to apparatus diagrams, system diagrams, and flowcharts that relate to SON or MDT data collection for small data.

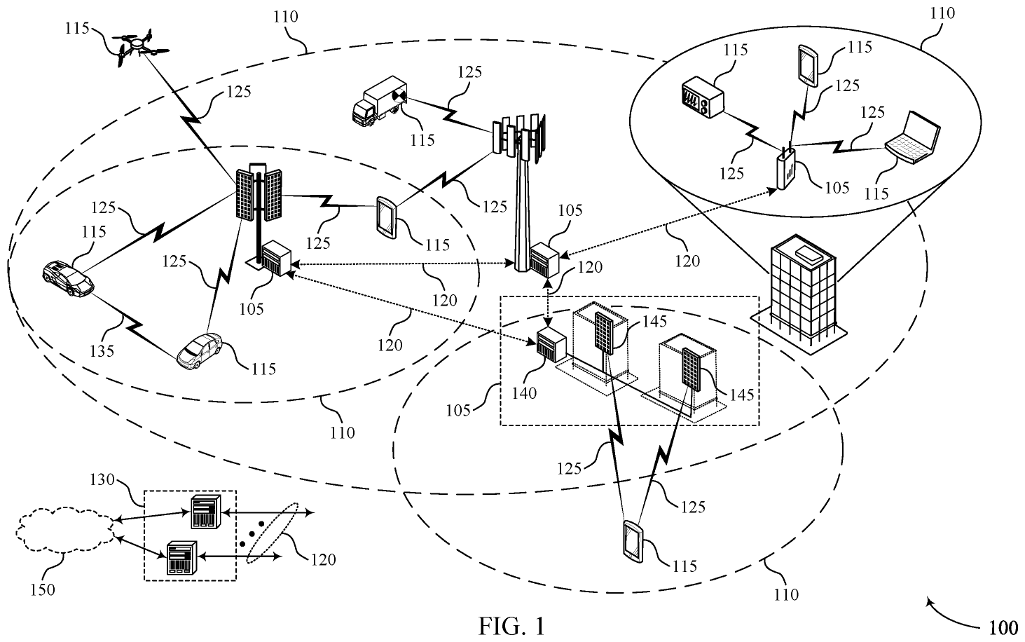

FIG. 1 illustrates an example of a wireless communications system 100 that supports SON or MDT data collection for small data in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some wireless communications systems may use SON or MDT techniques to enhance various aspects of wireless communications. For example, SON or MDT techniques may be used to improve immediate MDT operations, accessibility measurement procedures, mobility robustness optimization, mobility history information, mobility load balancing, logged MDT reporting, and RACH optimization, among other examples. For immediate MDT operations, SON or MDT techniques may be used to improve multi-RAT dual connectivity as well as LTE and NR dual connectivity. Additionally, SON or MDT techniques can be used to enhance beam and sensor measurements and measurement reports with location information as well as throughput, delay, and packet loss measurements at a radio access network (RAN) device (e.g., a base station 105) or a UE 115. For accessibility measurement procedures, SON or MDT techniques may be used to reduce failures (e.g., failures of RRCResume, beam level access failures), enhance sensor information, improve logging procedures for RRC setup failures, and enhance the acquisition of location information, among other examples.

For mobility robustness optimization, SON or MDT techniques can be employed to detect handover failure types, enhance beam level information in radio link failure (RLF) reports, or improve cross-RAT RLF reports as well as RLF reports with location information, among other examples. For mobility history information, SON or MDT techniques can be applied to identify LTE cells or NR cells visited by a UE 115 (e.g., while the UE 115 is in a dual connectivity mode) or to determine a mobility state (e.g., low, medium, high) of a UE 115. For mobility load balancing, SON or MDT techniques may be employed to perform event-triggered and inter-system load balancing, to calculate load metric exchange per beam or slice, to compute additional load metrics, or to improve the exchange of load information between base stations (e.g., RAN elements) over an interface (e.g., Xn, X2, F1, E1).

For logged MDT reporting, SON or MDT techniques can be applied to enhance multi-RAT dual connectivity, event-based logging, cell or beam-level measurements, inactive state (e.g., RRC_INACTIVE) operations, sensor measurements, or periodic logging of cell-level measurements in idle state (e.g., RRC_IDLE) with location information, among other examples. For RACH optimization, SON or MDT techniques can be used to improve 2-step RACH procedures, multiple RACH reports, random access attempts over various beams, or single RACH reports (e.g., for a most recent successful RACH procedure), among other examples.

Additionally or alternatively, some wireless communications systems may support SDTs. As described herein, an SDT may refer to an uplink data message that is transmitted by a UE 115 while the UE 115 is in an inactive state (e.g., RRC_INACTIVE). In some examples, a UE 115 may transmit an SDT in accordance with a RACH-based scheme or a CG-based scheme. RACH-based SDTs may be supported for 2-step and 4-step RACH procedures, which may be equivalently referred to herein as random access procedures. Generally, RACH-based SDTs may enable a UE 115 to perform user-plane data transmissions for small data packets while in an inactive state (e.g., using msgA or msg3). Some wireless communications systems may support flexible payload sizes (e.g., payload sizes larger than possible common control channel (CCCH) message sizes supported for inactive state transmissions using msgA and MSG3) to support uplink user-plane data transmissions. In some cases, an actual payload size of a RACH-based SDT can be determined from a network configuration. RACH-based SDTs may also support context fetch and data forwarding (e.g., with and without anchor relocation) for UEs in inactive states.

In other examples, a UE 115 may transmit an SDT in accordance with a CG-based scheme. In such examples, the UE 115 may transmit uplink data on preconfigured PUSCH resources (e.g., using a CG type-1) when a timing advance (TA) of the UE 115 is valid. That is, the UE 115 may perform a CG-based SDT over CG type-1 resources while the UE 115 is in an inactive state (e.g., with a valid TA). In some examples, the UE 115 may receive a configuration that pertains to using CG type-1 resources for transmission of uplink SDTs from an inactive state. In some examples, transmission of small data in uplink, subsequent transmission of small data in uplink and downlink, and state transition decisions may be controlled by the network (e.g., a base station 105). Some wireless communications systems may support SDTs on licensed carriers as well as in unlicensed radio frequency (RF) spectrum bands (e.g., NR-U). In addition, some wireless communications systems may support transmission of SDTs from inactive UEs via a signaling radio bearer (SRB), such as SRB1 or SRB2, based on a dedicated radio bearer (DRB) framework.

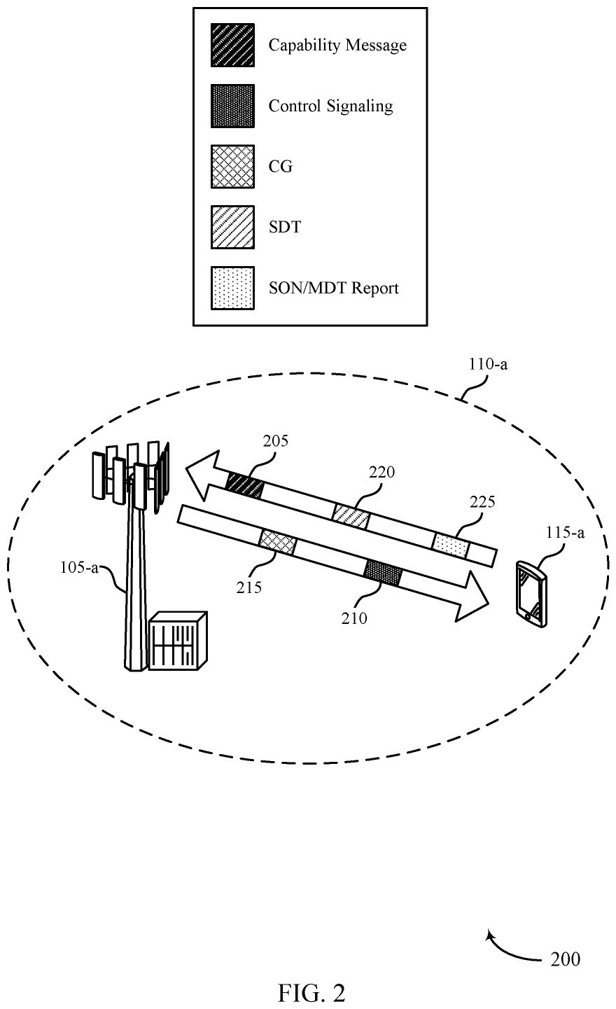

In accordance with the described techniques, a UE 115 may transmit an SDT to a base station 105 (e.g., using a RACH-based scheme or a CG-based scheme), and may generate a SON or MDT report based on transmitting the SDT. The SON or MDT report may include various IEs related to the SDT (as described with reference to FIG. 2), which the base station 105 may use to improve subsequent SDTs from the UE 115. The SON or MDT report may also include RACH-specific IEs, which the base station 105 may use to enhance subsequent RACH procedures performed by the UE 115. Configuring the UE 115 to transmit an SDT-related SON or MDT report may improve the reliability of communications between the UE 115 and the base station 105, among other benefits.

FIG. 2 illustrates an example of a wireless communications system 200 that supports SON or MDT data collection for small data in accordance with aspects of the present disclosure. The wireless communications system 200 may implement or be implemented by aspects of wireless communications system 100. For example, the wireless communications system 200 may include a UE 115-a and a base station 105-a, which may examples of corresponding devices described with reference to FIG. 1. The base station 105-a may be associated with a geographic coverage area 110-a, which may be an example of a geographic coverage area 110 described with reference to FIG. 1. In the wireless communications system 200, the UE 115-a may transmit an SDT 220 to the base station 105-a, and may generate a SON or MDT report 225 based on transmitting the SDT 220.

In accordance with aspects of the present disclosure, the base station 105-a may configure the UE 115-a to generate the SON or MDT report 225 for the SDT 220 such that the base station 105-a can use the SON or MDT report 225 to improve the likelihood of successful SDTs from the UE 115-a (e.g., by adjusting SDT resource allocations or transmission parameters for the UE 115-a) or to improve the likelihood of the UE 115-a successfully performing a RACH procedure (e.g., by adjusting RACH parameters used by the UE 115-a). That is, the base station 105-a may use the SON or MDT report 225 for CG-based SDT improvements, RACH-based SDT improvements, RACH procedure improvements, or a combination thereof. In some examples, the UE 115-a may transmit a capability message 205 to the base station 105-a. The capability message 205 may indicate a capability of the UE 115-a to generate SDT-related SON or MDT data. Accordingly, the base station 105-a may transmit control signaling 210 to the UE 115-a. The control signaling 210 may indicate a set of SON or MDT reporting criteria, which the UE 115-a may use to generate the SON or MDT report 225. In some examples, the set of SON or MDT reporting criteria may be based on the capability message 205 transmitted by the UE 115-a.

As an example, the base station 105-a may transmit a CG 215 to the UE 115-a. The CG 215 may indicate one or more PUSCH resources allocated for transmission of the SDT 220. Accordingly, the UE 115-a may attempt to transmit the SDT 220 on the PUSCH resources indicated by the CG 215, and may generate the SON or MDT report 225 based on the attempt. In another example, the UE 115-a may transmit the SDT 220 in a random access message (e.g., msgA or msg3), and may generate the SON or MDT report 225 based on whether the SDT 220 was successful. In some examples, the SON or MDT report 225 may be or may include a logged MDT report or an SDT report. The logged MDT report or the SDT report may be used to improve RACH-based SDTs (e.g., using msgA or msg3) and CG-based SDTs (e.g., using PUSCH resources). The UE 115-a may generate a logged MDT report or an SDT report for a successful CG-based SDT, a failed CG-based SDT, or a failed RACH-based SDT, among other examples.

The logged MDT report or the SDT report may include various IEs that can be used for SDT improvement. For example, the logged MDT report or the SDT report may include an SDT type with which the SDT 220 was initiated (e.g., CG-based SDT or RACH-based SDT), radio resource management (RRM) measurements of the base station 105-a (e.g., a serving or camped cell) during the SDT 220, cell measurements, beam measurements (e.g., synchronization signal (SS)-reference signal received power (RSRP)), preferred beam indices, an indication of whether an RSRP value is above or below a preconfigured supplementary uplink (SUL) or normal uplink (NUL) SDT-specific RSRP threshold, a payload size of an initial uplink transmission, an SDT data volume of the UE 115-a per DRB or SRB prior to initialization of an SDT procedure, a DRB or SRB identity, data volume of a DRB or SRB triggering the SDT 220, data volume of the UE 115-a prior to initialization of RACH-based SDT (which can be computed by the network or can be provided in the SON or MDT report 225), an RSRP value prior to the SDT 220, an indication of whether an RSRP value is above or below a preconfigured RSRP threshold (e.g., for SDT selection), an indication of whether a CG-based SDT was initiated and whether CG resources were released by the UE 115-a, a cause of the CG resource release (e.g., TA invalid, CG-SDT failure, reception of RRCRelease, cell-reselection), an indication of whether the UE 115-a has switched from CG-based SDT to RACH-based SDT prior to expiration of a timer at the UE 115-a (e.g., a T319-like timer) or prior to reception of an RRCRelease or RRCResume message at the UE 115-a, a cause of selecting a RACH-based SDT scheme (e.g., TA-SDT is valid or expired, no synchronization signal block (SSB) SS-RSRP above preconfigured threshold, cell-reselection), or a conditional inclusion of cause without an indicator of whether the UE 115-a has performed switching from CG-based SDT to RACH-based SDT, among other examples.

Additionally or alternatively, the logged MDT report or the SDT report may include an indication of whether CG or dynamic grant (DG) resources (e.g., from the CG 215) are to be used for subsequent data transmissions, a number of CG transmissions using CG resources, an average number of retransmissions on an SDT-DRB, an SDT volume of the UE 115-a per DRB or SRB when the UE 115-a performs switching from CG-based SDT to RACH-based SDT, an amount of data that has arrived at non-SDT radio bearers during the SDT 220, an amount of data that has arrived at SDT radio bearers during the SDT 220, an indication of which radio bearer types have the arrived data (e.g., SRBs, non-SDT DRBs, SDT DRBs) during the SDT 220, an indication of whether the UE 115-a has performed cell-reselection during the SDT 220 prior to expiration of a timer at the UE 115-a (e.g., a T319-like timer) or prior to reception of an RRCRelease or RRCResume message from the base station 105-a, an uplink PDCP delay measurement per SDT-DRB (which may involve extending an MDT framework for immediate MDT to an inactive state for the SDT 220), a traffic pattern of the UE 115-a (e.g., single short traffic or multiple short, traffic periodicity, average SDT data in each uplink transmission of the SDT 220). In some examples, if the UE 115-a switches from CG-based SDT to RACH-based SDT and the RACH procedure for the RACH-based SDT is unsuccessful, the UE 115-a may either generate a CEF report to indicate issues with the RACH procedure or include CEF-related parameters in the logged MDT or SDT report.

In some examples, the UE 115-a may determine whether a timer (e.g., a T319-like timer) related to a failure status of the SDT 220 has expired, and may determine which IEs to include in the SON or MDT report 225 based on whether the timer has expired or not. For example, if the UE 115-a determines that the timer has not expired, the UE 115-a may log (e.g., capture) parameters related to quality of service (QOS) verification in the SON or MDT report 225. Alternatively, if the UE 115-a determines that the timer has expired, the UE 115-a may generate (e.g., collect) failure-related parameters to reduce the likelihood of subsequent SDT failures.

The UE 115-a may use the SON or MDT report 225 to capture statistics related to a successful CG-based SDT. In such examples, the reporting mechanism of the UE 115-a may include a logged MDT report or SDT report. The UE 115-a may continue logging these statistics until an RRCRelease or RRCResume message is received by the UE 115-a (e.g., if a RACH procedure was successfully performed by the UE 115-a). The SON or MDT report 225 may include an SSB-identity, an SS-RSRP value, a time alignment timer (TAT)-SDT during the SDT 220, or an indication of SDT data that is available for transmission from the UE 115-a, among other examples.

If, for example, the UE 115-a determines that a timer related to a failure status of the SDT 220 (e.g., a CG-based SDT) has not expired prior to the UE 115-a receiving an RRCRelease message or an RRCResume message from the base station 105-a, the SON or MDT report 225 (e.g., a logged MDT report or an SDT report) may indicate an SDT type with which SDT was initiated (e.g., CG-based SDT or RACH-based SDT), an uplink PDCP delay measurement per SDT-DRB and SRB2 (which may involve extending an MDT framework for immediate MDT measurements to an inactive state for SDT), a traffic pattern of the UE 115-a (e.g., single short traffic, multiple short, traffic periodicity, average SDT data in each uplink transmission of the SDT 220), RRM measurements of the base station 105-a (e.g., a serving or camped cell of the UE 115-a during the SDT 220), cell measurements, beam measurements (e.g., SS-RSRP), preferred beam indices, an indication of whether an RSRP value is above or below a configured SUL or NUL SDT-specific RSRP threshold, a conditional inclusion of a random access report (e.g., if a RACH-based SDT is performed by the UE 115-a), a number of CG-transmissions performed by the UE 115-a on CG resources during an SDT procedure, an average number of RLC retransmissions per SDT-DRB during an SDT procedure, an amount of data that has arrived at non-SDT radio bearers during the SDT 220, an amount of data that has arrived at SDT radio bearers during the SDT 220, radio bearer types associated with arrived data (e.g., SRB, non-SDT DRBs, SDT DRBs) during an ongoing SDT procedure, an event indicating whether NAS has triggered another request for the UE 115-a to transition to a connected state (e.g., RRC_CONNECTED) when uplink data or a NAS message has arrived at non-SDT radio bears, or an elapsed time of the SDT 220 (e.g., a duration of time that the UE 115-a spends before switching to non-SDT based on network signaling or UE signaling from NAS) since initialization of the SDT 220, among other examples.

The UE 115-a may also use the SON or MDT report 225 to capture statistics (e.g., IEs, parameters) related to an unsuccessful CG-based SDT. In such examples, the reporting mechanism of the UE 115-a may include a logged MDT report, a CEF report, or an SDT report, among other examples. The UE may collect measurements based on expiration of a timer (e.g., a T319-like timer related to a failure status of the SDT 220) or based on detection of an integrity check failure while the timer is running. In such examples, the SON or MDT report 225 may include an SSB-identity, an SS-RSRP value, a TAT-SDT during the SDT 220, or SDT data that is available for transmission from the UE 115-a, among other examples.

As an example, if the UE 115-a determines that a timer related to a failure status of the SDT 220 (e.g., a CG-based SDT) has expired, the UE 115-a may generate a logged MDT report or an SDT report that indicates an SDT type with which SDT was initiated (e.g., CG-based SDT or RACH-based SDT), RRM measurements of the base station 105-a (e.g., a serving or camped cell of the UE 115-a during the SDT 220), cell measurements, beam measurements (e.g., SS-RSRP), preferred beam indices of the UE 115-a, an indication of whether an RSRP value is above or below a configured SUL or NUL SDT-specific RSRP threshold, a payload size in an initial uplink transmission or in a specific random access message (e.g., msgA or msg3), an SDT data volume of the UE 115-a per DRB or SRB prior to initialization of an SDT procedure, a DRB or SRB identity, data volume of a DRB or SRB triggering the SDT 220, a measured RSRP value prior to the SDT 220, an indication of whether the measured RSRP value is above or below a configured RSRP threshold (e.g., for SDT selection), and indication of whether the UE 115-a initiated a CG-based SDT and subsequently performed a CG resource release, a cause of releasing CG resources (e.g., TA invalid, CG-SDT failure, reception of RRCRelease, cell-reselection), an indication of whether the UE 115-a has switched from a CG-based SDT to a RACH-based SDT prior to expiration of a failure-related timer, a cause of selecting RACH-based SDT (e.g., TA timer (TA-SDT) is valid or expired, no SSB SS-RSRP above a configured threshold, cell-reselection), a conditional inclusion of cause without an indication of whether the UE 115-a switched from CG-based SDT to RACH-based SDT, an SDT volume of the UE 115-a per DRB or SRB when the UE 115-a switches from CG-based SDT to RACH-based SDT, an indication of whether cell-reselection has occurred during the SDT 220 prior to expiration of a timer at the UE 115-a, or an indication of whether an SDT-related RACH procedure performed by the UE 115-a is unsuccessful when switching from CG-based SDT to RACH-based SDT, among other examples.

In addition to using the SON or MDT report 225 for CG-based SDT improvements, the base station 105-a may also use the SON or MDT report 225 for RACH-based SDT improvements. Specifically, the UE 115-a may transmit the SON or MDT report 225 in response to a successful RACH-based SDT or an unsuccessful RACH-based SDT. For a successful RACH-based SDT, the reporting mechanism of the UE 115-a may include a RACH report, a logged MDT report, or an SDT report. The UE may continue logging SON or MDT data in the SON or MDT report 225 until the UE 115-a receives an RRCRelease message or an RRCResume message from the base station 105-a and while a timer of the UE 115-a (e.g., a T319-like timer related to a failure status of the SDT 220) has not expired, provided that the UE 115-a has performed a successful RACH procedure. The SON or MDT report 225 may include RACH resources or a RACH preamble used by the UE 115-a for the SDT 220, an indication of data available for transmission from the UE 115-a prior to the UE 115-a performing a RACH-based SDT, an RSRP value prior to the SDT 220, or an indication of whether SDT data is received (e.g., via an uplink channel) during the SDT 220, among other examples. To support RACH-based SDT improvements, event-based logging criteria can be defined for logging a RACH report (e.g., when a number of contentions is larger than a preconfigured threshold).

In some cases, the UE 115-a may log the RACH report upon successfully performing a RACH procedure with the base station 105-a. In other cases, the UE 115-a may also capture SDT statistics after performing a successful RACH procedure with the base station 105-a. In addition to the RACH report, the UE 115-a may also use a logged MDT or an SDT report to log information corresponding to a RACH-based SDT (e.g., to enhance msgA or msg3-based SDT procedures). As described herein, the UE 115-a may continue logging different fields in an SDT-related RACH report until the UE 115-a successfully receives an RRCResume message or an RRCRelease message from the base station 105-a.

For a successful RACH-based SDT, the RACH report may indicate an amount of data that has arrived at non-SDT radio bearers during the SDT 220, an amount of data that has arrived at SDT radio bearers during the SDT 220, radio bearer types associated with the arrived data (e.g., SRB, non-SDT DRBs, SDT DRBs) during an ongoing SDT procedure, whether the network (e.g., the base station 105-a) has switched from SDT to non-SDT, whether the UE 115-a has initiated a msgA or msg3-based SDT procedure prior to reception of an RRCRelease message or an RRCResume message from the base station 105-a, whether an SDT procedure was originally a CG-based SDT, whether a RACH-based SDT performed by the UE 115-a is based on the UE 115-a not having a valid CG configuration or a suitable beam, a cause of switching to a RACH-based SDT from a CG-based SDT (e.g., TA-SDT is invalid or expired, none of SSBs have an SS-RSRP higher than a configured threshold), whether NAS has triggered another request for the UE 115-a to transition to a connected state (e.g., RRC_CONNECTED) when uplink data or a NAS message has arrived at non-SDT radio bearers, or a time duration before the UE 115-a switched to non-SDT (e.g., based on network signaling or UE signaling from NAS) since initialization of the SDT 220, among other examples.

For an unsuccessful RACH-based SDT, the reporting mechanism of the UE 115-a may include a CEF report, a logged MDT report, or an SDT report, among other examples. The UE 115-a may collect measurements upon expiration of a timer at the UE 115-a (e.g., a T319-like timer related to a failure status of the SDT 220) or upon detection of an integrity check failure while the timer is running. The SON or MDT report 225 may include RACH resources or a RACH preamble used for the SDT 220, data that is available for transmission from the UE 115-a prior to the UE 115-a prior to the UE 115-a performing a RACH-based SDT, an RSRP value measured by the UE 115-a prior to the SDT 220, or an indication of whether SDT data is received (e.g., by the base station 105-a) in uplink during the SDT 220, among other examples.

In addition to using the SON or MDT report 225 for SDT improvements (e.g., RACH-based SDT improvements, CG-based SDT improvements), the base station 105-a may also use the SON or MDT report 225 for RACH enhancement. Specifically, the UE 115-a may generate SON or MDT data for RACH enhancement after performing a successful SDT-related RACH procedure or an unsuccessful SDT-related RACH procedure. For a successful SDT-related RACH procedure, the reporting mechanism of the UE 115-a may include a RACH report. The UE 115-a may collect (e.g., generate) measurements after successfully performing a RACH procedure with the base station 105-a. The RACH report may indicate RACH resources or a RACH preamble used for the SDT 220, data that is available for transmission from the UE 115-a prior to the UE 115-a performing a RACH-based SDT, or an RSRP value prior to the SDT 220, among other examples.

The RACH report may enable the base station 105-a to improve RACH resources used for RACH-based SDTs from the UE 115-a (e.g., using msgA or msg3). The UE 115-a may transmit the RACH report after successfully performing a random access procedure (e.g., after the UE 115-a receives contention resolution from the base station 105-a). The RACH report may indicate various RACH-related parameters, such as RACH resources used by the UE 115-a for transmission of the SDT 220, a preamble used by the UE 115-a for transmission of the SDT 220, a RACH purpose (e.g., small-data-transmission or an predefined RACH purpose) a data volume of the UE 115-a prior to initialization of an RACH-based SDT, an initial payload size (e.g., an SDT payload in msgA or msg3), an RSRP value prior to the SDT 220, an indication of whether msgA or msg3 is used by the UE 115-a for the SDT 220, or a RACH purpose indicating a specific random access message associated with the SDT 220 (e.g., msgA-based-SDT or msg3-based-SDT).

In some examples, the base station 105-a may implicitly determine which random access message includes the SDT 220 based on preconfigured IEs in the RACH report. Additionally or alternatively, event-based logging criteria can be defined for logging of the RACH report for SDT purposes (e.g., when a number of contentions is larger than a configured threshold). In some examples, predefined identifiers can be used to indicate SON or MDT data related to the SDT 220. For example, the RACH report may include predefined identifiers that indicate an RSRP value prior to the UE 115-a performing a RACH procedure (e.g., if the UE 115-a is configured to perform both 2-step and 4-step RACH procedures), whether a measured RSRP value is above or below a configured threshold value, whether contention is detected by the UE 115-a, or whether the UE 115-a performed a fallback procedure from 2-step to 4-step RACH, among other examples.

For unsuccessful RACH-based SDT attempts, the reporting mechanism of the UE 115-a may include a CEF report. The UE may collect measurements for the CEF report based on performing an unsuccessful RACH procedure (e.g., if no contention resolution is received by the UE 115-a). The CEF report may indicate RACH resources used by the UE 115-a for the SDT 220, a RACH preamble used by the UE 115-a for the SDT 220, data that is available for transmission from the UE 115-a prior to the UE 115-a performing a RACH-based SDT, or an RSRP value prior to the UE 115-a transmitting the SDT 220, among other examples.

The base station 105-a may use the CEF report to reduce RACH failures by adjusting resources used by the UE 115-a for RACH-based SDTs (e.g., SDTs included in msgA or msg3). If, for example, the UE 115-a does not receive a contention resolution message from the base station 105-a, the UE 115-a may use the CEF report to notify the base station 105-a of a coverage issue during the SDT 220. If the UE 115-a performs a RACH-based SDT and the UE 115-a does not receive a contention resolution message from the base station 105-a, the UE 115-a may include various fields in an CEF report after determining that a timer of the UE 115-a (e.g., a T319-like timer related to a failure status of the SDT 220) has expired. Specifically, the UE 115-a may include a random access information list (e.g., perRAInfoList), cell and beam SSB measurements, an SDT data volume of the UE 115-a per DRB or SRB prior to initialization of a RACH-based SDT, an initial payload size of the SDT 220 (e.g., an SDT payload in msgA or msg3), an indication of whether data has arrived at non-SDT radio bearers after a first uplink data transmission, or a combination thereof in the CEF report.

The described techniques may also support logging of listen before talk (LBT) failure information in the SON or MDT report 225. For example, if the UE 115-a attempts to transmit the SDT 220 in an unlicensed RF spectrum band (e.g., a shared spectrum), the SON or MDT report 225 may include LBT failure information related to the SDT 220. Specifically, the SON or MDT report 225 may include BWP information related to the SDT 220, a number of times that the UE 115-a detected an uplink LBT failure on a BWP prior to transmission of a corresponding RACH message (e.g., msg1, msgA, msg3), or an indication of whether the SDT 220 failed (e.g., whether a timer of the UE 115-a has expired) due to repeated uplink LBT failures, among other examples.

The SON or MDT reporting techniques described herein may be based on various UE capabilities and UE variables. For example, the UE 115-a may transmit a capability message 205 to the base station 105-a. The capability message 205 may indicate various SDT capabilities of the UE 115-a. For example, the capability message 205 may indicate a capability of the UE 115-a to obtain RACH information a for RACH-based SDT, a capability of the UE 115-a to obtain SDT statistics for a successful SDT, a capability of the UE 115-a to obtain SDT-related parameters for a failed SDT, or a capability of the UE 115-a to support SRB2 resume for SDTs, among other examples.

In some examples, if the SON or MDT report 225 is an example of an SDT report, a UE variable (e.g., varSDTReport) may be used to store various SDT parameters or IEs described herein. The UE 115-a may report the SON or MDT report 225 using at least two different reporting mechanisms. For example, the UE 115-a may transmit the SON or MDT report 225 while the UE 115-a is in connected state (e.g., RRC_CONNECTED) with the base station 105-a. In such examples, the UE 115-a may transmit the SON or MDT report 225 via a specific message (e.g., (EInformationResponse). Additionally or alternatively, the UE 115-a may indicate an availability of the SON or MDT report 225 in various RRC messages (e.g., RRCSetupComplete, RRCResumeComplete, RRCReeastblishmentComplete, or RROReconfigurationComplete, among other examples).

Alternatively, the UE 115-a may transmit the SON or MDT report 225 while the UE 115-a is in an inactive state (e.g., RRC_INACTIVE) with respect to the base station 105-a. In some examples, the UE 115-a may indicate an availability of the SON or MDT report 225 over SRB2 (e.g., if SRB2 is supported by the UE 115-a in an inactive state). In addition, the UE 115-a may use various messages (e.g., UEInformationRequest, UEInformationResponse) to report the SON or MDT report 225 from an inactive state. In some examples, the UE 115-a may filter the SON or MDT report 225 to include SDT-related SON or MDT data (e.g., the UE 115-a may refrain from reporting information that does not pertain to SDTs) when reporting the SON or MDT report 225 from an inactive state. Additionally or alternatively, a DRB-based reporting mechanism can be adapted to support reporting of a general purpose SDT report.

The described techniques may also support MDT measurements at a serving base station and an anchor base station. In the example of FIG. 2, the base station 105-a may be an example of either a serving base station or an anchor base station for the UE 115-a. In some examples, the described techniques may support extending an MDT framework for immediate MDT measurements to an inactive state for SDT QoS verification. These immediate MDT measurements may include a set of measurements associated with SDT data volume at the UE 115-a (e.g., M4 measurements), a set of measurements associated with SDT throughput levels at the UE 115-a (e.g., M5 measurements), a set of measurements associated with SDT packet delay at the UE 115-a (e.g., M6 measurements), or a set of measurements associated with SDT packet loss (e.g., M7 measurements), among other examples.

For SDT transmission without anchor reallocation, an anchor base station (e.g., the base station 105-a or a different base station) may send an MDT configuration (e.g., for SDT inactive state QoS verification) in a retrieve UE context failed message. In contrast to SDT transmission with anchor relocation (e.g., where the anchor base station can release the MDT configuration after forwarding the MDT configuration to a serving base station), the anchor base station may maintain the MDT configuration (e.g., context) in the case of SDT transmission without anchor relocation.

For SDT transmission (e.g., using a RACH-based scheme) with anchor relocation, the serving base station may compute a time difference between reception of msg3 and first downlink response data, a time difference between reception of msg3 and transmission of msg4 (e.g., a contention resolution message), or both. For RACH-based SDT transmission without anchor relocation, the serving base station may compute an amount of buffered RLC PDU between reception of msg3 and transmission of msg4 (e.g., a payload in a first RACH uplink transmission, a payload in a msgA or msg3 transmission), a time difference between reception of msg3 and first downlink response data, a time difference between reception of msg3 and transmission of msg4, or a combination thereof.

In some examples, the base station 105-a (e.g., the network) may request a random access report, a CEF report, a logged MDT report, an SDT report, or a combination thereof from the UE 115-a. Upon receiving this request from the base station 105-a, the UE 115-a may send the requested report to the base station 105-a such that the base station 105-a can use the report for SDT enhancement and RACH improvement.

The described techniques may improve the likelihood of the UE 115-a successfully transmitting SDTs to the base station 105-a. For example, the UE 115-a may transmit the SON or MDT report 225 to the base station 105-a, and the base station 105-a may use the SON or MDT report 225 to enhance or improve network configuration parameters for subsequent SDTs. Specifically, the base station 105-a may adjust resource allocations, modulation schemes, RACH parameters, timing parameters, or transmission schemes to improve the likelihood of the base station 105-a successfully receiving SDTs from the UE 115-a. Additionally, the base station 105-a may use the SON or MDT report 225 to improve RACH procedures performed by the UE 115-a. As a result, the described techniques may improve the reliability of communications between the UE 115-a and the base station 105-a, among other benefits.

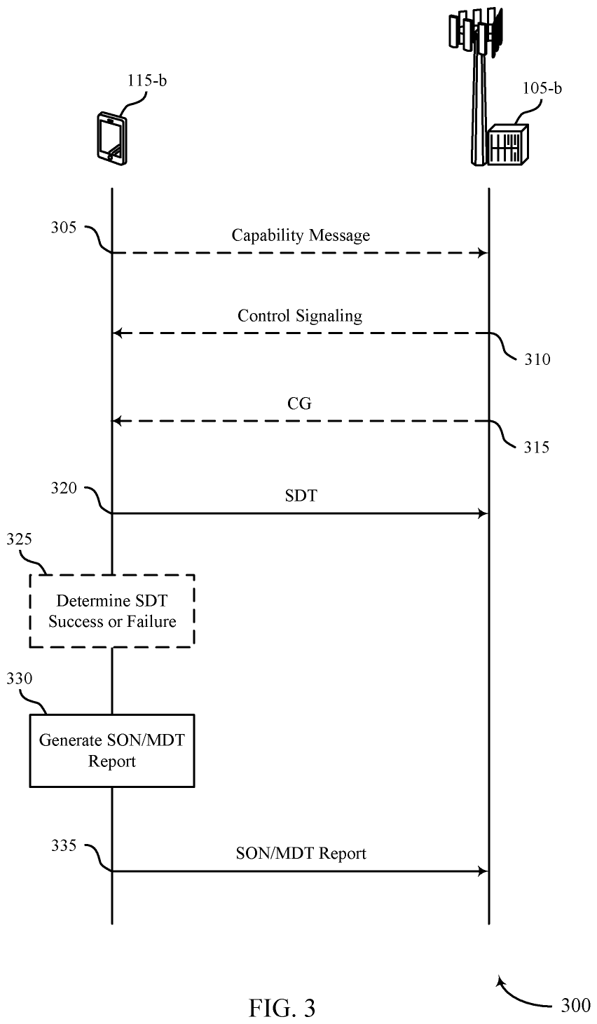

FIG. 3 illustrates an example of a process flow 300 that supports SON or MDT data collection for small data in accordance with aspects of the present disclosure. The process flow 300 may implement or be implemented by aspects of the wireless communications system 100 or the wireless communications system 200. For example, the process flow 300 may include a UE 115-b and a base station 105-b, which may be examples of corresponding devices described with reference to FIGS. 1 and 2. In the following description of the process flow 300, operations between the UE 115-b and the base station 105-b may be performed in a different order or at a different time than as shown. Additionally or alternatively, some operations may be omitted from the process flow 300, and other operations may be added to the process flow 300. In accordance with the process flow 300, the UE 115-b may transmit a SON or MDT report to the base station 105-b, and the base station 105-b may adjust one or more SDT-related network configuration parameters based on the SON or MDT report.

In some examples, the UE 115-b may transmit a capability message to the base station 105-b at 305. The capability message may indicate a capability of the UE 115-b to generate SON or MDT data for SDT improvements, RACH enhancements, or both. Additionally or alternatively, the base station 105-b may transmit control signaling to the UE 115-b at 310. The control signaling may indicate a set of SON or MDT reporting criteria, which the UE 115-b may use to generate an SDT-related SON or MDT report. In some cases, the set of SON or MDT reporting criteria may be based on the capability message transmitted by the UE 115-b. In some examples, the base station 105-b may transmit a CG to the UE 115-b in accordance with a CG-based communications procedure. The CG may indicate one or more PUSCH resources allocated for transmission of an SDT.

At 320, the UE 115-b may transmit an SDT to the base station 105-b in accordance with a communications procedure. The SDT may be an example of a CG-based SDT (e.g., an SDT transmitted on configured PUSCH resources) or a RACH-based SDT (e.g., an SDT transmitted in a random access message, such as msgA or msg3). That is, the UE 115-b may transmit the SDT in accordance with a CG or in accordance with a random access procedure. The SDT may have a payload size (e.g., may include a number of bits) that is below a preconfigured threshold. The UE 115-b may transmit the SDT while the UE 115-b is in an inactive state (e.g., RRC_INACTIVE) with respect to communications with the base station 105-b. The UE 115-b may transmit the SDT via one or more DRBs or SRBs (e.g., SDT radio bearers, non-SDT radio bearers, SRB2). At 325, the UE 115-b may determine whether the SDT was successful or unsuccessful. In some examples, the UE 115-b may determine that the SDT was unsuccessful based on expiration of a timer at the UE 115-b (e.g., a T319-like timer related to a failure status of the SDT), detection of an integrity check failure at the UE 115-b, or an outcome of a RACH procedure (e.g., if the UE 115-b does not receive a contention resolution message from the base station 105-b).

At 330, the UE 115-b may generate a SON or MDT report based on determining whether the SDT was successful or unsuccessful. The UE 115-b may also generate the SON or MDT report based on a communication procedure (e.g., RACH or CG) associated with the SDT. For example, if the SDT is a successful CG-based SDT, the UE 115-b may generate a logged MDT report or an SDT report. If the SDT is an unsuccessful CG-based SDT, the UE 115-b may generate a logged MDT report, a CEF report, or an SDT report. If the SDT is a successful RACH-based SDT, the UE 115-b may generate a RACH report, a logged MDT report, or an SDT report. If the SDT is an unsuccessful RACH-based SDT, the UE 115-b may generate a CEF report, a logged MDT report, or an SDT report. For RACH-based SDTs, the UE 115-b may also generate the SON or MDT report based on an outcome of a RACH procedure associated with the RACH-based SDT. For example, if the UE 115-b performs a successful RACH procedure while attempting to transmit the SDT, the UE 115-b may generate a RACH report. Alternatively, if the UE 115-b performs an unsuccessful RACH procedure (e.g., if the UE 115-b does not receive a contention resolution message from the base station 105-b) in an attempt to transmit the SDT, the UE 115-b may generate a CEF report.

The SON or MDT report may include various fields (e.g., IEs, parameters, statistics) related to the SDT, the communication procedure associated with the SDT (e.g., RACH or CG), or both. For example, the SON or MDT report may indicate RACH parameters used for transmission of the SDT, timing information related to the SDT, channel measurements associated with the SDT, a payload size of the SDT, whether the UE 115-b switched from a CG-based communications procedure to a RACH-based communications procedure, radio bearer information associated with the SDT, traffic pattern information pertaining to the UE 115-b, data volume information pertaining to the UE 115-b, QoS verification parameters, SDT failure parameters, or LBT failure information (e.g., if the UE 115-b transmits the SDT in an unlicensed RF spectrum band), among other examples. In some examples, the UE 115-b may continue logging information in the SON or MDT report until the UE 115-b receives an RRCResume message or an RRCRelease message from the base station 105-b.

At 335, the UE 115-b may transmit the SON or MDT report to the base station 105-b. The UE 115-b may transmit the SON or MDT report to the base station 105-b while the UE 115-b is in a connected state (e.g., RRC_CONNECTED) or an inactive state (e.g., RRC_INACTIVE) with respect to communications with the base station 105-b. In some examples, the UE 115-b may indicate an availability of the SON or MDT report to the base station 105-b (e.g., in various RRC messages). Accordingly, the base station 105-b may request the SON or MDT report from the UE 115-b, and the UE 115-b may transmit the SON or MDT report to the base station 105-b in response to the request.

The base station 105-b may use the SON or MDT report for SDT improvement, RACH enhancement, or both. For example, the base station 105-b may use the SON or MDT report to increase the likelihood of the base station 105-b successfully receiving subsequent SDTs from the UE 115-b. Additionally or alternatively, the base station 105-b may use the SON or MDT report to determine suitable RACH parameters (e.g., preambles, resources, radio bearers) for the UE 115-b. As such, configuring the UE 115-b to generate and transmit a SON or MDT report in accordance with aspects of the present disclosure may improve the reliability of communications between the base station 105-b and the UE 115-b.

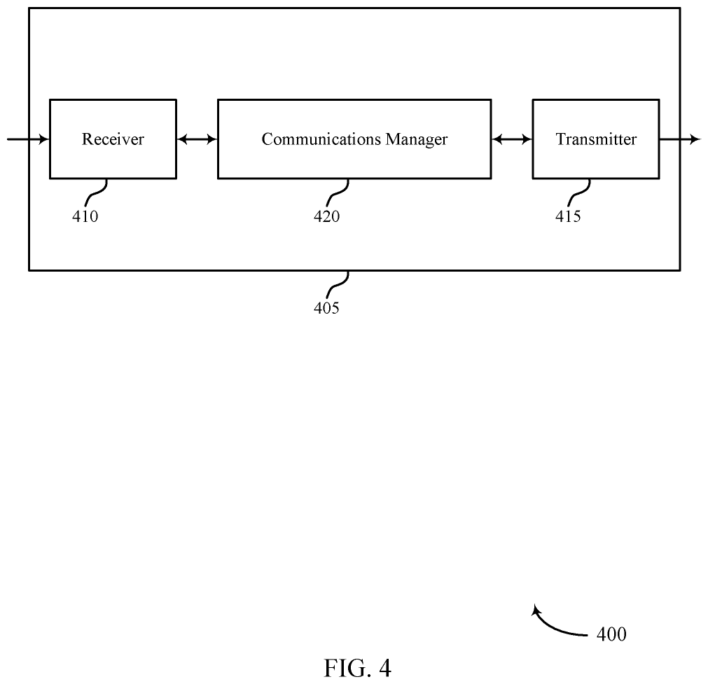

FIG. 4 shows a block diagram 400 of a device 405 that supports SON or MDT data collection for small data in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to SON or MDT data collection for small data). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to SON or MDT data collection for small data). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of SON or MDT data collection for small data as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at the device 405 (e.g., a UE 115) in accordance with examples as disclosed herein. For example, the communications manager 420 may be configured as or otherwise support a means for transmitting, in accordance with a communications procedure, an uplink data message to a base station while the device 405 is in an inactive mode with respect to communications with the base station. The communications manager 420 may be configured as or otherwise support a means for generating a report that includes one or more parameters pertaining to uplink data message transmission to the base station, where the one or more parameters included in the report are based on the communications procedure associated with the uplink data message and on whether transmission of the uplink data message to the base station was successful. The communications manager 420 may be configured as or otherwise support a means for transmitting the report to the base station.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced power consumption based on reducing a number of retransmissions performed by the device 405. For example, the described techniques may enable the device 405 to transmit a SON or MDT report for SDT improvement, RACH enhancement or both. Transmitting the SON or MDT report may increase the likelihood that SDTs transmitted by the device 405 are successfully received, and may also reduce the number of unsuccessful RACH procedures performed by the device 405. As a result, the device 405 may perform fewer SDT retransmissions, which may enable the device 405 to remain in a sleep mode for a longer duration, among other benefits.

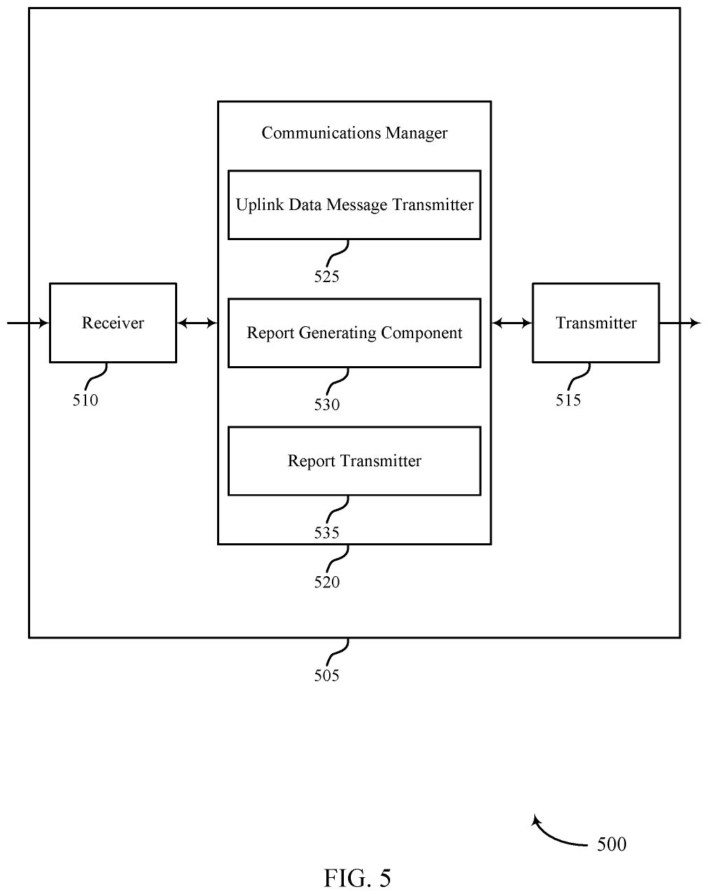

FIG. 5 shows a block diagram 500 of a device 505 that supports SON or MDT data collection for small data in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to SON or MDT data collection for small data). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SON or MDT data collection for small data). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of SON or MDT data collection for small data as described herein. For example, the communications manager 520 may include an uplink data message transmitter 525, a report generating component 530, a report transmitter 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at the device 505 (e.g., a UE 115) in accordance with examples as disclosed herein. The uplink data message transmitter 525 may be configured as or otherwise support a means for transmitting, in accordance with a communications procedure, an uplink data message to a base station while the device 505 is in an inactive mode with respect to communications with the base station. The report generating component 530 may be configured as or otherwise support a means for generating a report that includes one or more parameters pertaining to uplink data message transmission to the base station, where the one or more parameters included in the report are based on the communications procedure associated with the uplink data message and on whether transmission of the uplink data message to the base station was successful. The report transmitter 535 may be configured as or otherwise support a means for transmitting the report to the base station.

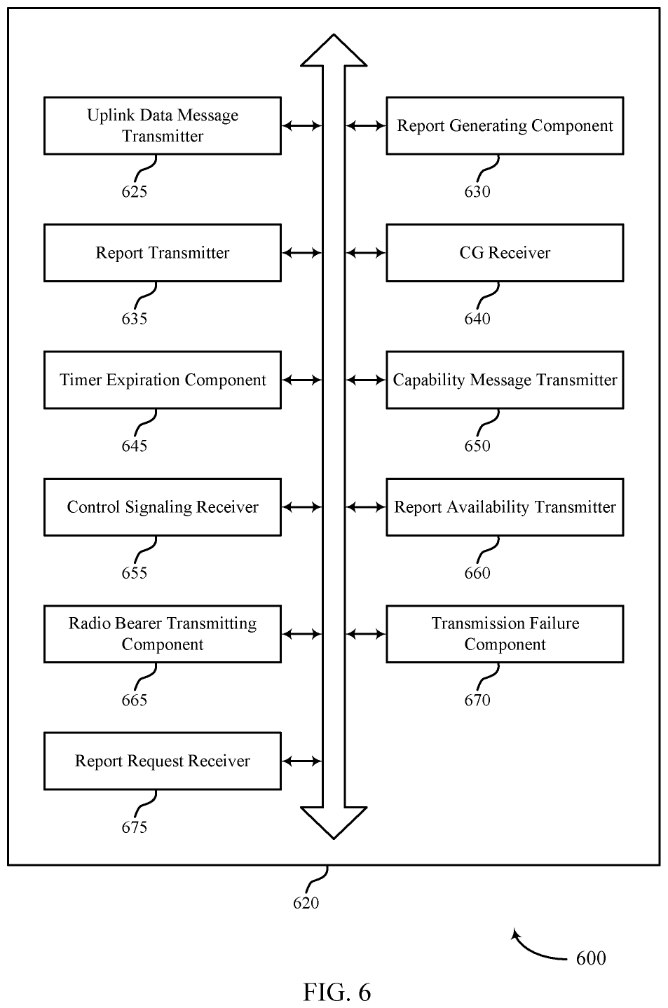

FIG. 6 shows a block diagram 600 of a communications manager 620 that supports SON or MDT data collection for small data in accordance with aspects of the present disclosure. The communications manager 620 may be an example of aspects of a communications manager 420, a communications manager 520, or both, as described herein. The communications manager 620, or various components thereof, may be an example of means for performing various aspects of SON or MDT data collection for small data as described herein. For example, the communications manager 620 may include an uplink data message transmitter 625, a report generating component 630, a report transmitter 635, a CG receiver 640, a timer expiration component 645, a capability message transmitter 650, a control signaling receiver 655, a report availability transmitter 660, a radio bearer transmitting component 665, a transmission failure component 670, a report request receiver 675, or any combination thereof. Each of these components may communicate, directly or indirectly, with one another (e.g., via one or more buses).

The communications manager 620 may support wireless communications at the device 605 (e.g., a UE 115) in accordance with examples as disclosed herein. The uplink data message transmitter 625 may be configured as or otherwise support a means for transmitting, in accordance with a communications procedure, an uplink data message to a base station while the device 605 is in an inactive mode with respect to communications with the base station. The report generating component 630 may be configured as or otherwise support a means for generating a report that includes one or more parameters pertaining to uplink data message transmission to the base station, where the one or more parameters included in the report are based on the communications procedure associated with the uplink data message and on whether transmission of the uplink data message to the base station was successful. The report transmitter 635 may be configured as or otherwise support a means for transmitting the report to the base station.

In some examples, to support transmitting the report, the report transmitter 635 may be configured as or otherwise support a means for transmitting the report to the base station for enhancement of subsequent uplink data message transmissions from the device 605, improvement of random access procedures and resources used for subsequent uplink data message transmissions from the device 605, or both.

In some examples, to support transmitting the uplink data message, the CG receiver 640 may be configured as or otherwise support a means for receiving, from the base station, a CG indicating one or more PUSCH resources. In some examples, to support transmitting the uplink data message, the uplink data message transmitter 625 may be configured as or otherwise support a means for transmitting the uplink data message to the base station on the one or more PUSCH resources in accordance with the CG, where the communications procedure is the CG.

In some examples, to support transmitting the uplink data message, the uplink data message transmitter 625 may be configured as or otherwise support a means for transmitting the uplink data message to the base station on a RACH in accordance with a random access procedure, where the communications procedure is the random access procedure.

In some examples, to support transmitting the uplink data message on the RACH, the uplink data message transmitter 625 may be configured as or otherwise support a means for transmitting the uplink data message via the RACH based on a prior attempt to transmit the uplink data message to the base station in accordance with a CG being unsuccessful.

In some examples, to support generating the report, the report generating component 630 may be configured as or otherwise support a means for generating a random access report based on successful transmission of the uplink data message on the RACH, where the one or more parameters included in the random access report include a set of random access parameters used for transmission of the uplink data message, a preamble used for transmission of the uplink data message, a set of channel measurements pertaining to the communications procedure, data volume information pertaining to the device 605, payload information related to the uplink data message, event-based logging information related to transmission of the uplink data message, an indication of a random access message used for transmission of the uplink data message, an indication of a random access purpose associated with the uplink data message, an indication of whether the device 605 has detected contention during the communications procedure, an indication of whether the device 605 has performed a RACH fallback procedure during transmission of the uplink data message, or a combination thereof.

In some examples, to support generating the random access report, the report generating component 630 may be configured as or otherwise support a means for generating the random access report based on successful transmission of the uplink data message on the RACH, where the one or more parameters included in the random access report include data arrival information related to the uplink data message, radio bearer information associated with the uplink data message, network transmission type switching information associated with the communications procedure, timing information associated with a start of the communications procedure, an indication of whether the device 605 has switched communications procedures during transmission of the uplink data message, NAS event-triggering information related to the communications procedure, timing information related to the uplink data message, or a combination thereof.

In some examples, to support generating the random access report, the report generating component 630 may be configured as or otherwise support a means for logging the one or more parameters of the random access report until a connection release message or a connection resume message is received from the base station.

In some examples, to support generating the report, the report generating component 630 may be configured as or otherwise support a means for generating a logged MDT report or an SDT report based on successful transmission of the uplink data message on the RACH.

In some examples, the transmission failure component 670 may be configured as or otherwise support a means for determining that transmission of the uplink data message on the RACH was unsuccessful based on a failure of the random access procedure, expiration of a timer related to a failure status of the uplink data message, detection of an integrity check failure at the device 605, or a combination thereof.

In some examples, to support generating the report, the report generating component 630 may be configured as or otherwise support a means for generating a CEF report, a logged MDT report, or an SDT report based on failure of the transmission of the uplink data message on the RACH.

In some examples, to support generating the report, the report generating component 630 may be configured as or otherwise support a means for generating a CEF report based on determining that the transmission of the uplink data message on the RACH was unsuccessful, where the CEF report includes a set of random access parameters used for transmission of the uplink data message, a set of channel measurements related to transmission of the uplink data message, data volume information pertaining to the device 605, payload information associated with the uplink data message, data arrival information related to transmission of the uplink data message, or a combination thereof.

In some examples, to support generating the report, the report generating component 630 may be configured as or otherwise support a means for generating a logged MDT report or an SDT report based on the communications procedure being a CG or on the communications procedure being a successful random access procedure, where the one or more parameters of the logged MDT report or the SDT report include an SDT type used for transmission of the uplink data message, a set of channel measurements associated with transmission of the uplink data message, payload information related to the uplink data message, data volume information pertaining to the device 605, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, CG resource release information associated with the communications procedure, an indication of whether the device 605 has switched communications procedures during transmission of the uplink data message, cell reselection information related to the communications procedure, an indication of CG resources or dynamic grant resources used for transmission of the uplink data message, QoS metrics associated with transmission of the uplink data message, or a combination thereof.

In some examples, to support generating the report, the timer expiration component 645 may be configured as or otherwise support a means for determining that a timer related to a failure status of the uplink data message has not expired. In some examples, to support generating the report, the report generating component 630 may be configured as or otherwise support a means for generating a logged MDT report or an SDT report based on determining that the timer has not expired, where the one or more parameters of the logged MDT report or the SDT report include an SDT type used for transmission of the uplink data message, event-based logging information related to transmission of the uplink data message, a set of channel measurements associated with transmission of the uplink data message, traffic pattern information related to the uplink data message, retransmission information associated with the uplink data message, data arrival information related to the uplink data message, radio bearer information related to the uplink data message, timing information associated with transmission of the uplink data message, NAS event-triggering information pertaining to the communications procedure, network transmission type switching information associated with the communications procedure, or a combination thereof.

In some examples, to support generating the report, the timer expiration component 645 may be configured as or otherwise support a means for determining that a timer related to a failure status of the uplink data message has expired. In some examples, to support generating the report, the report generating component 630 may be configured as or otherwise support a means for generating a logged MDT report or an SDT report based on determining that the timer has expired, where the one or more parameters of the logged MDT report or the SDT report include an SDT type used for transmission of the uplink data message, a set of channel measurements associated with transmission of the uplink data message, payload information related to the uplink data message, data volume information pertaining to the device 605, event-based logging information related to transmission of the uplink data message, CG resource release information associated with the communications procedure, an indication of whether the device 605 has switched communications procedures during transmission of the uplink data message, cell reselection information related to the communications procedure, or a combination thereof.

In some examples, to support transmitting the uplink data message, the uplink data message transmitter 625 may be configured as or otherwise support a means for transmitting an SDT message as the uplink data message while the device 605 is in the inactive mode based on the uplink data message having a payload size that is below a preconfigured threshold.

In some examples, to support generating the report, the report generating component 630 may be configured as or otherwise support a means for generating the report based on transmitting the uplink data message in an unlicensed radio frequency spectrum band, where the one or more parameters of the report include bandwidth part information related to transmission of the uplink data message, listen before talk failure information associated with transmission of the uplink data message, a failure status of the uplink data message, or a combination thereof.

In some examples, to support transmitting the report, the report transmitter 635 may be configured as or otherwise support a means for transmitting the report to the base station while the device 605 is in a connected mode or an inactive mode with respect to communications with the base station.

In some examples, the capability message transmitter 650 may be configured as or otherwise support a means for transmitting, to the base station, a capability message indicating a capability of the device 605 to generate SON or MDT reporting information for SDTs. In some examples, the control signaling receiver 655 may be configured as or otherwise support a means for receiving, from the base station and based on the capability message, control signaling that indicates a set of SON or MDT reporting criteria, where generating the report is based on the set of SON or MDT reporting criteria.

In some examples, the report availability transmitter 660 may be configured as or otherwise support a means for transmitting, to the base station and based on generating the report, an indication that the report is available for transmission.

In some examples, the report request receiver 675 may be configured as or otherwise support a means for receiving, from the base station and in response to the indication, a request for the device 605 to transmit the report, where transmitting the report is based on receiving the request.

In some examples, the radio bearer transmitting component 665 may be configured as or otherwise support a means for transmitting the uplink data message, the report, an indication that the report is available for transmission, or a combination thereof via one or more SRBs or DRBs.

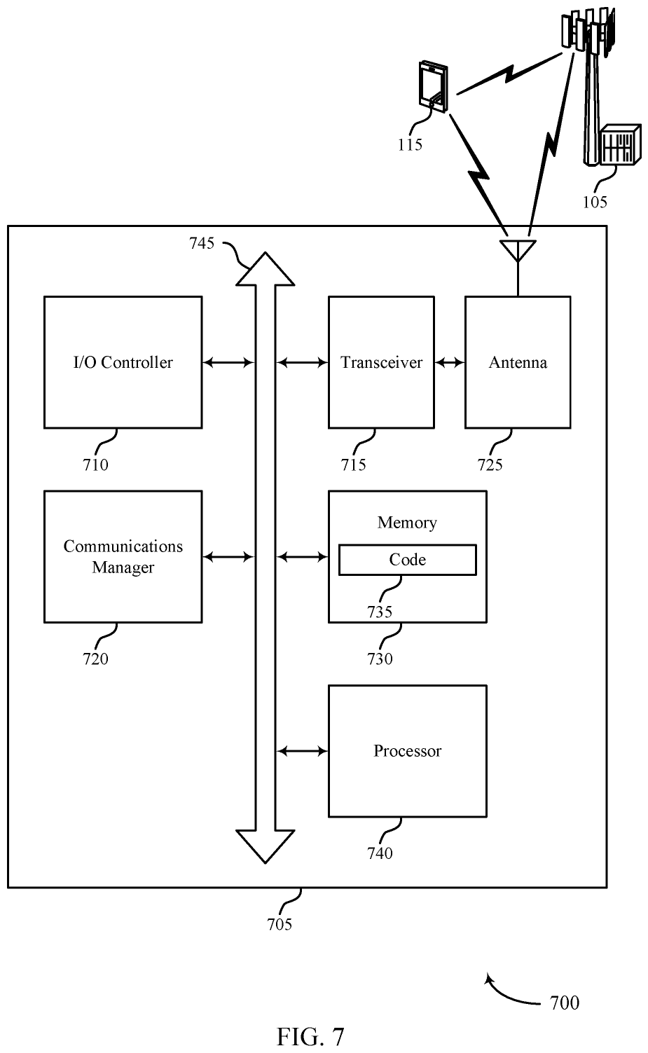

FIG. 7 shows a diagram of a system 700 including a device 705 that supports SON or MDT data collection for small data in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting SON or MDT data collection for small data). For example, the device 705 or a component of the device 705 may include a processor 740 and memory 730 coupled to the processor 740, the processor 740 and memory 730 configured to perform various functions described herein.

The communications manager 720 may support wireless communications at the device 705 (e.g., a UE 115) in accordance with examples as disclosed herein. For example, the communications manager 720 may be configured as or otherwise support a means for transmitting, in accordance with a communications procedure, an uplink data message to a base station while the device 705 is in an inactive mode with respect to communications with the base station. The communications manager 720 may be configured as or otherwise support a means for generating a report that includes one or more parameters pertaining to uplink data message transmission to the base station, where the one or more parameters included in the report are based on the communications procedure associated with the uplink data message and on whether transmission of the uplink data message to the base station was successful. The communications manager 720 may be configured as or otherwise support a means for transmitting the report to the base station.

By including or configuring the communications manager 720 in accordance with examples as described herein, the device 705 may support techniques for more efficient utilization of communication resources based on using a SON or MDT report for SDT enhancement and RACH improvement. For example, the described techniques may enable the device 705 to report SDT-related SON or MDT data to a base station 105 (or another network entity) such that the base station 105 can use the SON or MDT data to improve subsequent SDTs and RACH procedures performed by the device 705.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of SON or MDT data collection for small data as described herein, or the processor 740 and the memory 730 may be otherwise configured to perform or support such operations.

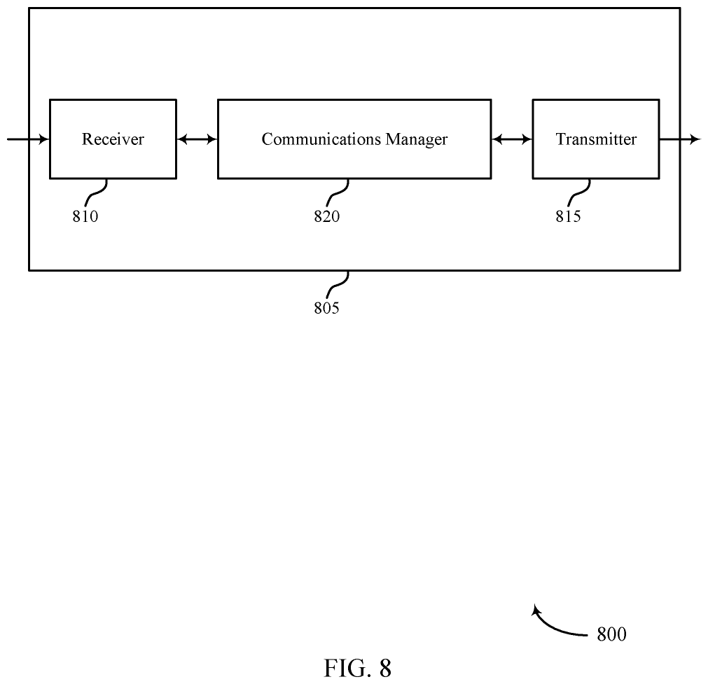

FIG. 8 shows a block diagram 800 of a device 805 that supports SON or MDT data collection for small data in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to SON or MDT data collection for small data). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SON or MDT data collection for small data). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of SON or MDT data collection for small data as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at the device 805 (e.g., a base station 105) in accordance with examples as disclosed herein. For example, the communications manager 820 may be configured as or otherwise support a means for transmitting, to a UE, control signaling that indicates a set of SON or MDT reporting criteria. The communications manager 820 may be configured as or otherwise support a means for receiving a report from the UE in accordance with the set of SON or MDT reporting criteria, where the report includes one or more parameters pertaining to an attempt by the UE to transmit an uplink data message to the device 805 while the UE is in an inactive mode with respect to communications with the device 805, where the one or more parameters included in the report are based on a communications procedure associated with the uplink data message and on whether transmission of the uplink data message to the device 805 was successful.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing and lower signaling overhead based on reducing a number of RACH procedures performed by the device 805. For example, the described techniques may enable a UE 115 to transmit small data to the device 805 from an inactive state rather than establishing a connection with the device 805 (e.g., via a RACH procedure) prior to transmitting the small data to the device 805. As a result, the device 805 may perform fewer RACH procedures, which may result in lower signaling overhead at the device 805, among other benefits.

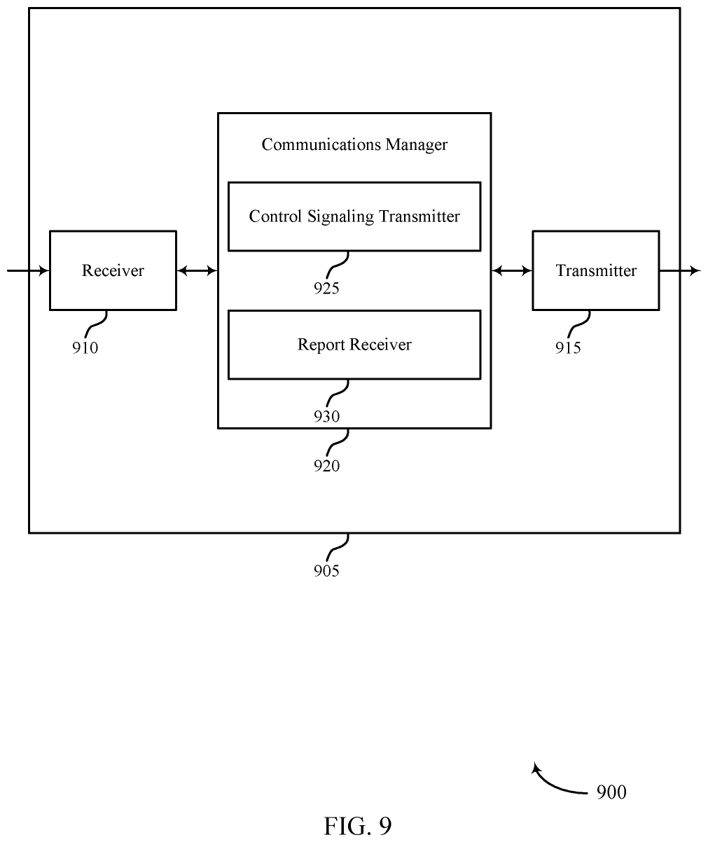

FIG. 9 shows a block diagram 900 of a device 905 that supports SON or MDT data collection for small data in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to SON or MDT data collection for small data). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SON or MDT data collection for small data). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SON or MDT data collection for small data as described herein. For example, the communications manager 920 may include a control signaling transmitter 925 a report receiver 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at the device 905 (e.g., a base station 105) in accordance with examples as disclosed herein. The control signaling transmitter 925 may be configured as or otherwise support a means for transmitting, to a UE, control signaling that indicates a set of SON or MDT reporting criteria. The report receiver 930 may be configured as or otherwise support a means for receiving a report from the UE in accordance with the set of SON or MDT reporting criteria, where the report includes one or more parameters pertaining to an attempt by the UE to transmit an uplink data message to the device 905 while the UE is in an inactive mode with respect to communications with the device 905, and where the one or more parameters included in the report are based on a communications procedure associated with the uplink data message and on whether transmission of the uplink data message to the device 905 was successful.

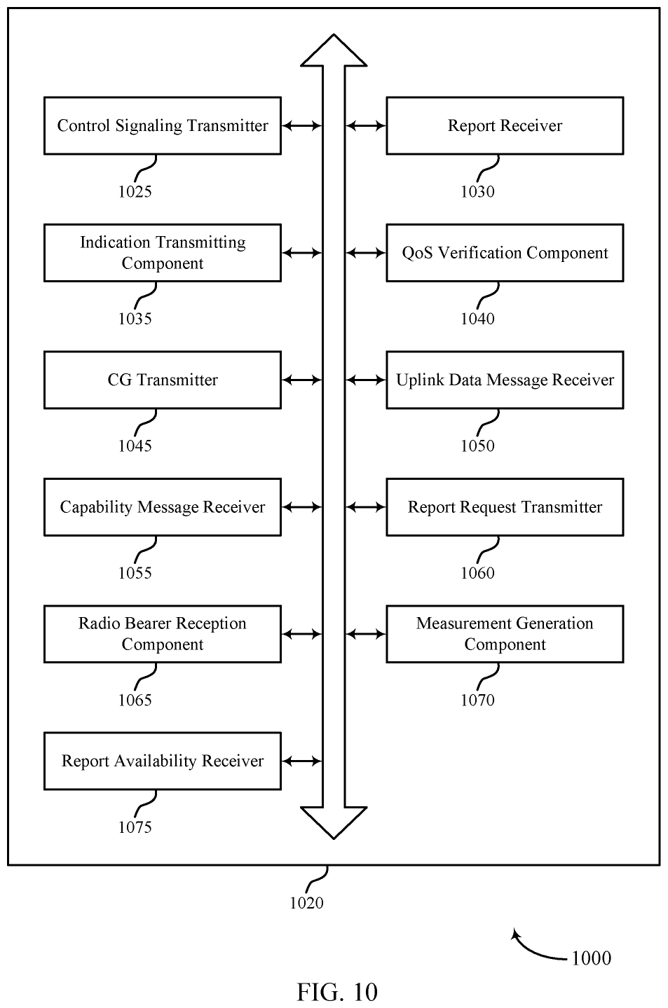

FIG. 10 shows a block diagram 1000 of a communications manager 1020 that supports SON or MDT data collection for small data in accordance with aspects of the present disclosure. The communications manager 1020 may be an example of aspects of a communications manager 820, a communications manager 920, or both, as described herein. The communications manager 1020, or various components thereof, may be an example of means for performing various aspects of SON or MDT data collection for small data as described herein. For example, the communications manager 1020 may include a control signaling transmitter 1025, a report receiver 1030, an indication transmitting component 1035, a QoS verification component 1040, a CG transmitter 1045, an uplink data message receiver 1050, a capability message receiver 1055, a report request transmitter 1060, a radio bearer reception component 1065, a measurement generation component 1070, a report availability receiver 1075, or any combination thereof. Each of these components may communicate, directly or indirectly, with one another (e.g., via one or more buses).

The communications manager 1020 may support wireless communications at the device 1005 (e.g., a base station 105) in accordance with examples as disclosed herein. The control signaling transmitter 1025 may be configured as or otherwise support a means for transmitting, to a UE, control signaling that indicates a set of SON or MDT reporting criteria. The report receiver 1030 may be configured as or otherwise support a means for receiving a report from the UE in accordance with the set of SON or MDT reporting criteria, where the report includes one or more parameters pertaining to an attempt by the UE to transmit an uplink data message to the device 1005 while the UE is in an inactive mode with respect to communications with the device 1005, and where the one or more parameters included in the report are based on a communications procedure associated with the uplink data message and on whether transmission of the uplink data message to the device 1005 was successful.

In some examples, to support receiving the report, the report receiver 1030 may be configured as or otherwise support a means for receiving the report from the UE for enhancement of subsequent uplink data message transmissions from the UE, improvement of random access procedures and resources used for subsequent uplink data message transmissions from the UE, or both.

In some examples, the indication transmitting component 1035 may be configured as or otherwise support a means for transmitting, to a serving base station of the UE, an indication of the report, an indication of a MDT configuration pertaining to the UE, or both. In some examples, the device 1005 may be an anchor base station for the UE or a serving base station of the UE.

In some examples, the QoS verification component 1040 may be configured as or otherwise support a means for performing a QoS verification procedure based on receiving the report from the UE.

In some examples, the CG transmitter 1045 may be configured as or otherwise support a means for transmitting, to the UE, a CG indicating one or more PUSCH resources. In some examples, the uplink data message receiver 1050 may be configured as or otherwise support a means for receiving the uplink data message from the UE on the one or more PUSCH resources in accordance with the CG, where the communications procedure is the CG.

In some examples, the uplink data message receiver 1050 may be configured as or otherwise support a means for receiving the uplink data message from the UE on a RACH in accordance with a random access procedure, where the communications procedure is the random access procedure.

In some examples, the measurement generation component 1070 may be configured as or otherwise support a means for generating a set of measurements related to the random access procedure, where the set of measurements includes a time difference between reception of a random access message and transmission of downlink data, a time difference between reception of the random access message and transmission of a second random access message, a payload size of the random access message, a payload size of the second random access message, or a combination thereof.

In some examples, to support receiving the report, the report receiver 1030 may be configured as or otherwise support a means for receiving a random access report from the UE based on successful reception of the uplink data message on the RACH, where the one or more parameters included in the random access report include a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a RACH fallback procedure during transmission of the uplink data message, or a combination thereof.

In some examples, to support receiving the random access report, the report receiver 1030 may be configured as or otherwise support a means for receiving the random access report from the UE based on successful reception of the uplink data message on the RACH, where the one or more parameters included in the random access report include data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, NAS event-triggering information associated with the communications procedure, timing information related to the uplink data message, or a combination thereof.

In some examples, to support receiving the report, the report receiver 1030 may be configured as or otherwise support a means for receiving a CEF report, a logged MDT report, or an SDT report from the UE based on unsuccessful reception of the uplink data message.

In some examples, to support receiving the report, the report receiver 1030 may be configured as or otherwise support a means for receiving a random access report, a logged MDT report, or an SDT report from the UE based on successful reception of the uplink data message.

In some examples, to support receiving the report, the report receiver 1030 may be configured as or otherwise support a means for receiving a CEF report from the UE based on unsuccessful reception of the uplink data message on a RACH, where the one or more parameters included in the CEF report include a set of random access parameters related to the uplink data message, a set of channel measurements related to transmission of the uplink data message, data volume information pertaining to the UE, payload information associated with the uplink data message, data arrival information related to the uplink data message, or a combination thereof.

In some examples, to support receiving the report, the report receiver 1030 may be configured as or otherwise support a means for receiving a logged MDT report or an SDT report based on the communications procedure being a CG or on the communications procedure being a successful random access procedure, where the one or more parameters of the logged MDT report or the SDT report include an SDT type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, CG resource release information associated with the communications procedure, an indication of whether the UE has switched communications procedures during transmission of the uplink data message, cell reselection information related to the communications procedure, an indication of CG resources or dynamic grant resources used for transmission of the uplink data message, QoS metrics associated with transmission of the uplink data message, or a combination thereof.

In some examples, the uplink data message receiver 1050 may be configured as or otherwise support a means for receiving an SDT message as the uplink data message while the UE is in the inactive mode based on the uplink data message having a payload size that is below a preconfigured threshold.

In some examples, to support receiving the report, the report receiver 1030 may be configured as or otherwise support a means for receiving the report based on an attempt by the UE to transmit the uplink data message in an unlicensed radio frequency spectrum band, where the one or more parameters of the report include bandwidth part information related to transmission of the uplink data message, listen before talk failure information associated with transmission of the uplink data message, a failure status of the uplink data message, or a combination thereof.

In some examples, to support receiving the report, the report receiver 1030 may be configured as or otherwise support a means for receiving the report from the UE while the UE is in a connected mode or an inactive mode with respect to communications with the device 1005.

In some examples, the capability message receiver 1055 may be configured as or otherwise support a means for receiving, from the UE, a capability message indicating a capability of the UE to generate SON or MDT reporting information for SDTs, where transmitting the control signaling to the UE is based on the capability message.

In some examples, the report request transmitter 1060 may be configured as or otherwise support a means for transmitting a request for the report to the UE, where receiving the report from the UE is based on the request.

In some examples, the report availability receiver 1075 may be configured as or otherwise support a means for receiving, from the UE, an indication that the report is available for transmission, where transmitting the request is based on receiving the indication.

In some examples, the radio bearer reception component 1065 may be configured as or otherwise support a means for receiving the uplink data message, the report, an indication that the report is available for transmission, or a combination thereof via one or more SRBs or DRBs in accordance with the set of SON or MDT reporting criteria.

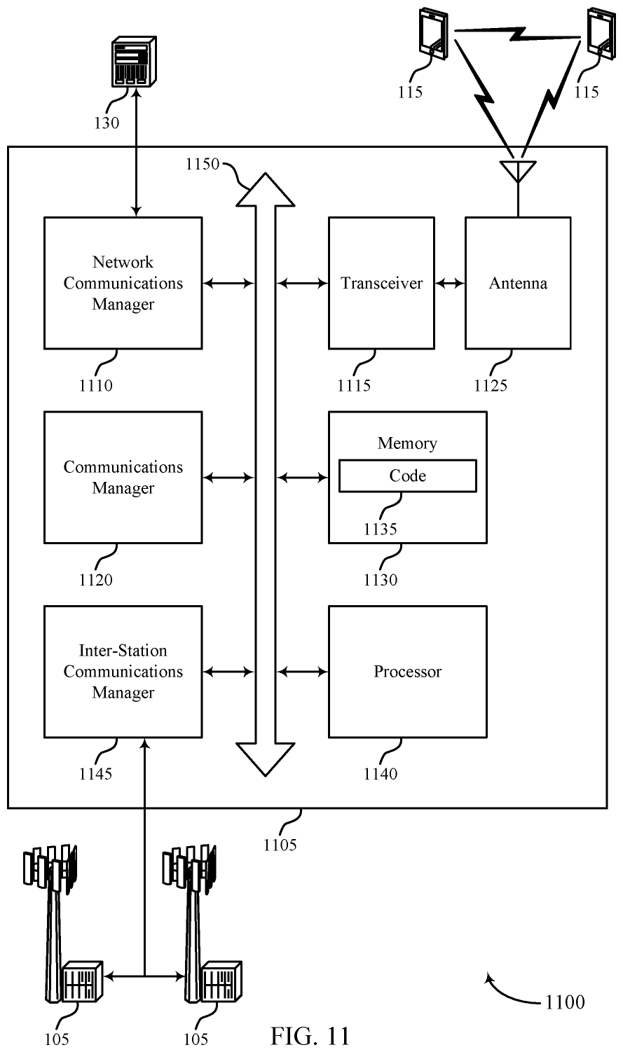

FIG. 11 shows a diagram of a system 1100 including a device 1105 that supports SON or MDT data collection for small data in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting SON or MDT data collection for small data). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at the device 1105 (e.g., a base station 105) in accordance with examples as disclosed herein. For example, the communications manager 1120 may be configured as or otherwise support a means for transmitting, to a UE, control signaling that indicates a set of SON or MDT reporting criteria. The communications manager 1120 may be configured as or otherwise support a means for receiving a report from the UE in accordance with the set of SON or MDT reporting criteria, where the report includes one or more parameters pertaining to an attempt by the UE to transmit an uplink data message to the device 1105 while the UE is in an inactive mode with respect to communications with the device 1105, and where the one or more parameters included in the report are based on a communications procedure associated with the uplink data message and on whether transmission of the uplink data message to the device 1105 was successful.

By including or configuring the communications manager 1120 in accordance with examples as described herein, the device 1105 may support techniques for improved communication reliability based on receiving a SON or MDT report from a UE 115. For example, the device 1105 may use a SON or MDT report from a UE 115 to adjust SDT-related network configuration parameters (e.g., resource allocations, transmission parameters, modulation schemes), which may increase the likelihood of the device 1105 successfully receiving SDTs from the UE 115. As such, the UE 115 may transmit SDTs to the device 1105 from an inactive state rather than establishing a connection with the device 1105, which may result in lower signaling overhead at the device 1105, among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of SON or MDT data collection for small data as described herein, or the processor 1140 and the memory 1130 may be otherwise configured to perform or support such operations.

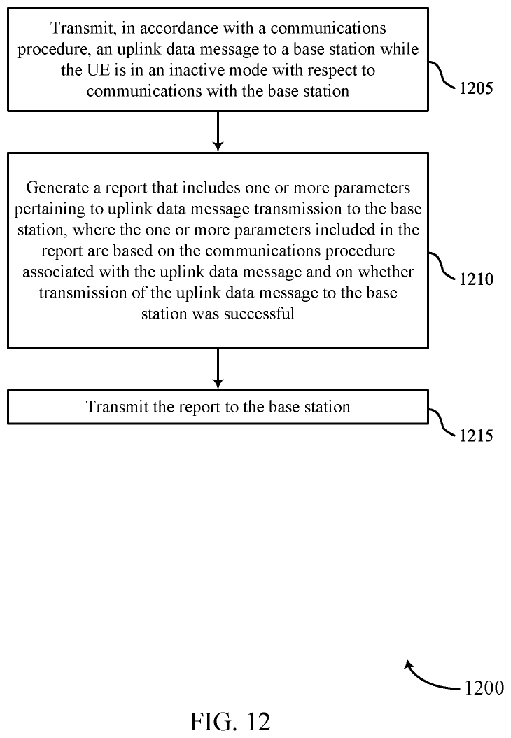

FIG. 12 shows a flowchart illustrating a method 1200 that supports SON or MDT data collection for small data in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include transmitting, in accordance with a communications procedure, an uplink data message to a base station while the UE is in an inactive mode with respect to communications with the base station. The operations of 1205 may be performed in accordance with examples as disclosed herein. In some examples, aspects of the operations of 1205 may be performed by an uplink data message transmitter 625 as described with reference to FIG. 6.

At 1210, the method may include generating a report that includes one or more parameters pertaining to uplink data message transmission to the base station, where the one or more parameters included in the report are based on the communications procedure associated with the uplink data message and on whether transmission of the uplink data message to the base station was successful. The operations of 1210 may be performed in accordance with examples as disclosed herein. In some examples, aspects of the operations of 1210 may be performed by a report generating component 630 as described with reference to FIG. 6.

At 1215, the method may include transmitting the report to the base station. The operations of 1215 may be performed in accordance with examples as disclosed herein. In some examples, aspects of the operations of 1215 may be performed by a report transmitter 635 as described with reference to FIG. 6.

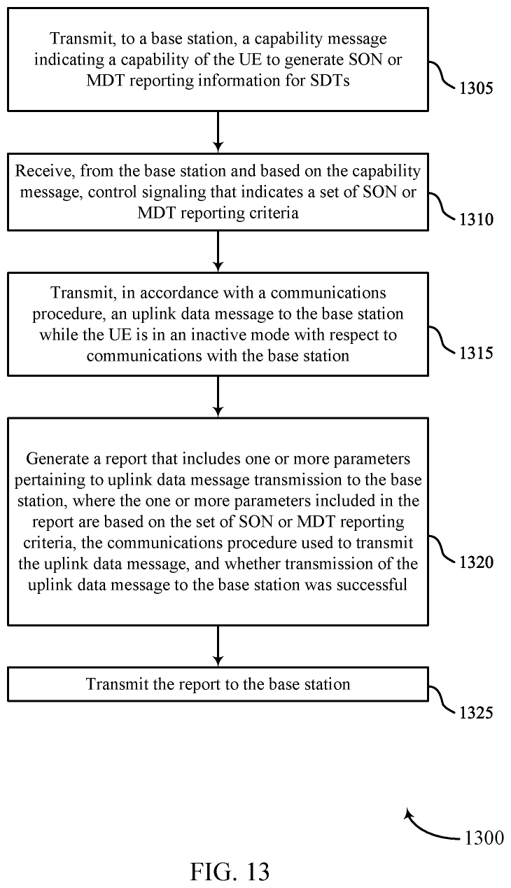

FIG. 13 shows a flowchart illustrating a method 1300 that supports SON or MDT data collection for small data in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include transmitting, to the base station, a capability message indicating a capability of the UE to generate SON or MDT reporting information for SDTs. The operations of 1305 may be performed in accordance with examples as disclosed herein. In some examples, aspects of the operations of 1305 may be performed by a capability message transmitter 650 as described with reference to FIG. 6.

At 1310, the method may include receiving, from the base station and based on the capability message, control signaling that indicates a set of SON or MDT reporting criteria. The operations of 1310 may be performed in accordance with examples as disclosed herein. In some examples, aspects of the operations of 1310 may be performed by a control signaling receiver 655 as described with reference to FIG. 6.

At 1315, the method may include transmitting, in accordance with a communications procedure, an uplink data message to a base station while the UE is in an inactive mode with respect to communications with the base station. The operations of 1315 may be performed in accordance with examples as disclosed herein. In some examples, aspects of the operations of 1315 may be performed by an uplink data message transmitter 625 as described with reference to FIG. 6.

At 1320, the method may include generating a report that includes one or more parameters pertaining to uplink data message transmission to the base station, where the one or more parameters included in the report are based on the set of SON or MDT reporting criteria, the communications procedure associated with the uplink data message, and whether transmission of the uplink data message to the base station was successful. The operations of 1320 may be performed in accordance with examples as disclosed herein. In some examples, aspects of the operations of 1320 may be performed by a report generating component 630 as described with reference to FIG. 6.

At 1325, the method may include transmitting the report to the base station. The operations of 1325 may be performed in accordance with examples as disclosed herein. In some examples, aspects of the operations of 1325 may be performed by a report transmitter 635 as described with reference to FIG. 6.

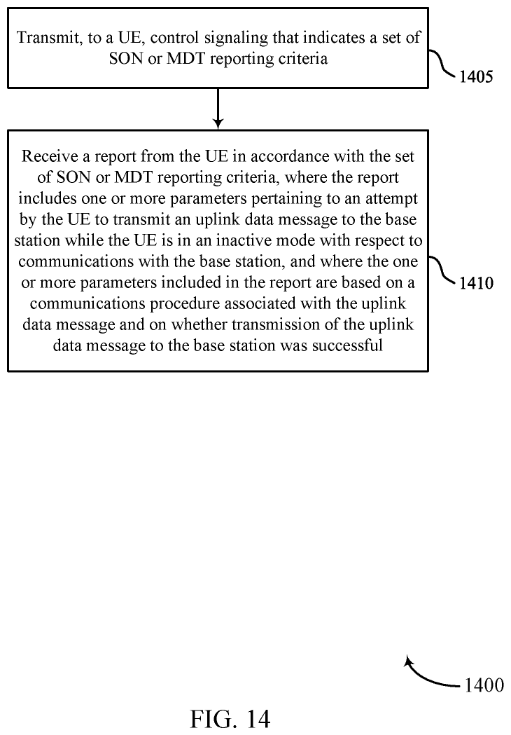

FIG. 14 shows a flowchart illustrating a method 1400 that supports SON or MDT data collection for small data in accordance with aspects of the present disclosure. The operations of the method 1400 may be implemented by a base station or its components as described herein. For example, the operations of the method 1400 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1405, the method may include transmitting, to a UE, control signaling that indicates a set of SON or MDT reporting criteria. The operations of 1405 may be performed in accordance with examples as disclosed herein. In some examples, aspects of the operations of 1405 may be performed by a control signaling transmitter 1025 as described with reference to FIG. 10.

At 1410, the method may include receiving a report from the UE in accordance with the set of SON or MDT reporting criteria, where the report includes one or more parameters pertaining to an attempt by the UE to transmit an uplink data message to the base station while the UE is in an inactive mode with respect to communications with the base station, and where the one or more parameters included in the report are based on a communications procedure associated with the uplink data message and on whether transmission of the uplink data message to the base station was successful. The operations of 1410 may be performed in accordance with examples as disclosed herein. In some examples, aspects of the operations of 1410 may be performed by a report receiver 1030 as described with reference to FIG. 10.

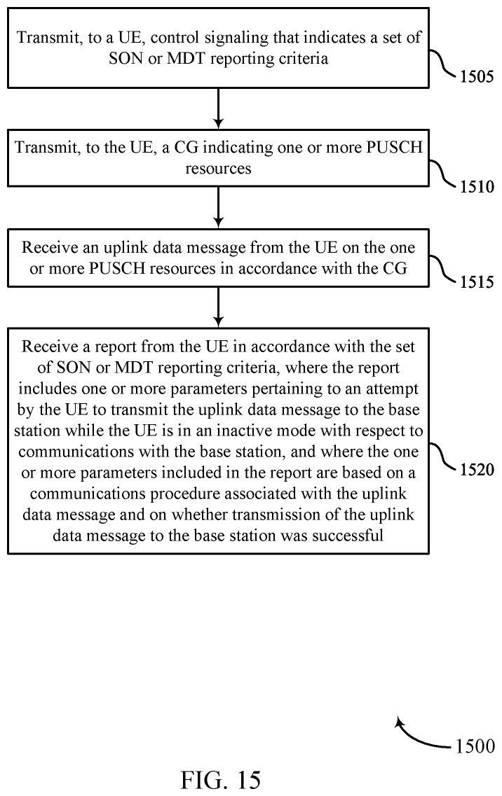

FIG. 15 shows a flowchart illustrating a method 1500 that supports SON or MDT data collection for small data in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling that indicates a set of SON or MDT reporting criteria. The operations of 1505 may be performed in accordance with examples as disclosed herein. In some examples, aspects of the operations of 1505 may be performed by a control signaling transmitter 1025 as described with reference to FIG. 10.

At 1510, the method may include transmitting, to the UE, a CG indicating one or more PUSCH resources. The operations of 1510 may be performed in accordance with examples as disclosed herein. In some examples, aspects of the operations of 1510 may be performed by a CG transmitter 1045 as described with reference to FIG. 10.

At 1515, the method may include receiving an uplink data message from the UE on the one or more PUSCH resources in accordance with the CG. The operations of 1515 may be performed in accordance with examples as disclosed herein. In some examples, aspects of the operations of 1515 may be performed by an uplink data message receiver 1050 as described with reference to FIG. 10.

At 1520, the method may include receiving a report from the UE in accordance with the set of SON or MDT reporting criteria, where the report includes one or more parameters pertaining to an attempt by the UE to transmit the uplink data message to the base station while the UE is in an inactive mode with respect to communications with the base station, and where the one or more parameters included in the report are based on a communications procedure (e.g., the CG) associated with the uplink data message and on whether transmission of the uplink data message to the base station was successful. The operations of 1520 may be performed in accordance with examples as disclosed herein. In some examples, aspects of the operations of 1520 may be performed by a report receiver 1030 as described with reference to FIG. 10.

The following provides an overview of aspects of the present disclosure:

Aspect 1: A method for wireless communications at a UE, comprising: transmitting, in accordance with a communications procedure, an uplink data message to a base station while the UE is in an inactive mode with respect to communications with the base station; generating a report that includes one or more parameters pertaining to uplink data message transmission to the base station, wherein the one or more parameters included in the report are based at least in part on the communications procedure associated with the uplink data message and on whether transmission of the uplink data message to the base station was successful; and transmitting the report to the base station.

Aspect 2: The method of aspect 1, wherein transmitting the report comprises: transmitting the report to the base station for enhancement of subsequent uplink data message transmissions from the UE, improvement of random access procedures and resources used for subsequent uplink data message transmissions from the UE, or both.

Aspect 3: The method of any of aspects 1 through 2, wherein transmitting the uplink data message comprises: receiving, from the base station, a configured grant indicating one or more physical uplink shared channel resources; and transmitting the uplink data message to the base station on the one or more physical uplink shared channel resources in accordance with the configured grant, wherein the communications procedure is the configured grant.

Aspect 4: The method of any of aspects 1 through 2, wherein transmitting the uplink data message comprises: transmitting the uplink data message to the base station on a random access channel in accordance with a random access procedure, wherein the communications procedure is the random access procedure.

Aspect 5: The method of aspect 4, wherein transmitting the uplink data message on the random access channel further comprises: transmitting the uplink data message via the random access channel based at least in part on a prior attempt to transmit the uplink data message to the base station in accordance with a configured grant being unsuccessful.

Aspect 6: The method of any of aspects 4 through 5, wherein generating the report comprises: generating a random access report based at least in part on successful transmission of the uplink data message on the random access channel, wherein the one or more parameters included in the random access report comprise a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a random access channel fallback procedure during transmission of the uplink data message, or a combination thereof.

Aspect 7: The method of aspect 6, wherein generating the random access report comprises: generating the random access report based at least in part on successful transmission of the uplink data message on the random access channel, wherein the one or more parameters included in the random access report comprise data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, non-access stratum event-triggering information related to the communications procedure, timing information related to the uplink data message, or a combination thereof.

Aspect 8: The method of any of aspects 6 through 7, wherein generating the random access report comprises: logging the one or more parameters of the random access report until a connection release message or a connection resume message is received from the base station.

Aspect 9: The method of any of aspects 4 through 5, wherein generating the report comprises: generating a logged minimization of drive test report or a small data transmission report based at least in part on successful transmission of the uplink data message on the random access channel.

Aspect 10: The method of any of aspects 4 through 5, further comprising: determining that transmission of the uplink data message on the random access channel was unsuccessful based at least in part on a failure of the random access procedure, expiration of a timer related to a failure status of the uplink data message, detection of an integrity check failure at the UE, or a combination thereof.

Aspect 11: The method of aspect 10, wherein generating the report

comprises: generating a connection establishment failure report, a logged minimization of drive test report, or a small data transmission report based at least in part on failure of the transmission of the uplink data message on the random access channel.

Aspect 12: The method of any of aspects 10 through 11, wherein generating the report comprises: generating a connection establishment failure report based at least in part on determining that the transmission of the uplink data message on the random access channel was unsuccessful, wherein the connection establishment failure report comprises a set of random access parameters used for transmission of the uplink data message, a set of channel measurements related to transmission of the uplink data message, data volume information pertaining to the UE, payload information associated with the uplink data message, data arrival information related to transmission of the uplink data message, or a combination thereof.

Aspect 13: The method of any of aspects 1 through 5, wherein generating the report comprises: generating a logged minimization of drive test report or a small data transmission report based at least in part on the communications procedure being a configured grant or on the communications procedure being a successful random access procedure, wherein the one or more parameters of the logged minimization of drive test report or the small data transmission report comprise a small data transmission type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, configured grant resource release information associated with the communications procedure, an indication of whether the UE has switched communications procedures during transmission of the uplink data message, cell reselection information related to the communications procedure, an indication of configured grant resources or dynamic grant resources used for transmission of the uplink data message, quality of service metrics associated with transmission of the uplink data message, or a combination thereof.

Aspect 14: The method of any of aspects 1 through 5, wherein generating the report comprises: determining that a timer related to a failure status of the uplink data message has not expired; and generating a logged minimization of drive test report or a small data transmission report based at least in part on determining that the timer has not expired, wherein the one or more parameters of the logged minimization of drive test report or the small data transmission report comprise a small data transmission type used for transmission of the uplink data message, event-based logging information related to transmission of the uplink data message, a set of channel measurements associated with transmission of the uplink data message, traffic pattern information related to the uplink data message, retransmission information associated with the uplink data message, data arrival information related to the uplink data message, radio bearer information related to the uplink data message, timing information associated with transmission of the uplink data message, non-access stratum event-triggering information pertaining to the communications procedure, network transmission type switching information associated with the communications procedure, or a combination thereof.

Aspect 15: The method of any of aspects 1 through 5, wherein generating the report comprises: determining that a timer related to a failure status of the uplink data message has expired; and generating a logged minimization of drive test report or a small data transmission report based at least in part on determining that the timer has expired, wherein the one or more parameters of the logged minimization of drive test report or the small data transmission report comprise a small data transmission type used for transmission of the uplink data message, a set of channel measurements associated with transmission of the uplink data message, payload information related to the uplink data message, data volume information pertaining to the UE, event-based logging information related to transmission of the uplink data message, configured grant resource release information associated with the communications procedure, an indication of whether the UE has switched communications procedures during transmission of the uplink data message, cell reselection information related to the communications procedure, or a combination thereof.

Aspect 16: The method of any of aspects 1 through 15, wherein transmitting the uplink data message further comprises: transmitting a small data transmission message as the uplink data message while the UE is in the inactive mode based at least in part on the uplink data message having a payload size that is below a preconfigured threshold.

Aspect 17: The method of any of aspects 1 through 16, wherein generating the report comprises: generating the report based at least in part on transmitting the uplink data message in an unlicensed radio frequency spectrum band, wherein the one or more parameters of the report comprise bandwidth part information related to transmission of the uplink data message, listen before talk failure information associated with transmission of the uplink data message, a failure status of the uplink data message, or a combination thereof.

Aspect 18: The method of any of aspects 1 through 17, wherein transmitting the report comprises: transmitting the report to the base station while the UE is in a connected mode or an inactive mode with respect to communications with the base station.

Aspect 19: The method of any of aspects 1 through 18, further comprising: transmitting, to the base station, a capability message indicating a capability of the UE to generate self-organizing network or minimization of drive test reporting information for small data transmissions; and receiving, from the base station and based at least in part on the capability message, control signaling that indicates a set of self-organizing network or minimization of drive test reporting criteria, wherein generating the report is based at least in part on the set of self-organizing network or minimization of drive test reporting criteria.

Aspect 20: The method of any of aspects 1 through 19, further comprising: transmitting, to the base station and based at least in part on generating the report, an indication that the report is available for transmission.

Aspect 21: The method of aspect 20, further comprising: receiving, from the base station and in response to the indication, a request for the UE to transmit the report, wherein transmitting the report is based at least in part on receiving the request.

Aspect 22: The method of any of aspects 1 through 21, further comprising: transmitting the uplink data message, the report, an indication that the report is available for transmission, or a combination thereof via one or more signaling radio bearers or dedicated radio bearers.

Aspect 23: A method for wireless communications at a base station, comprising: transmitting, to a UE, control signaling that indicates a set of self-organizing network or minimization of drive test reporting criteria; receiving a report from the UE in accordance with the set of self-organizing network or minimization of drive test reporting criteria, wherein the report includes one or more parameters pertaining to an attempt by the UE to transmit an uplink data message to the base station while the UE is in an inactive mode with respect to communications with the base station, and wherein the one or more parameters included in the report are based at least in part on a communications procedure associated with the uplink data message and on whether transmission of the uplink data message to the base station was successful.

Aspect 24: The method of aspect 23, wherein receiving the report comprises: receiving the report from the UE for enhancement of subsequent uplink data message transmissions from the UE, improvement of random access procedures and resources used for subsequent uplink data message transmissions from the UE, or both.

Aspect 25: The method of any of aspects 23 through 24, further comprising: transmitting, to a serving base station of the UE, an indication of the report, an indication of a minimization of drive test configuration pertaining to the UE, or both.

Aspect 26: The method of any of aspects 23 through 25, wherein the base station is an anchor base station for the UE or a serving base station of the UE.

Aspect 27: The method of any of aspects 23 through 26, further comprising: performing a quality of service verification procedure based at least in part on receiving the report from the UE.

Aspect 28: The method of any of aspects 23 through 27, further comprising: transmitting, to the UE, a configured grant indicating one or more physical uplink shared channel resources; and receiving the uplink data message from the UE on the one or more physical uplink shared channel resources in accordance with the configured grant, wherein the communications procedure is the configured grant.

Aspect 29: The method of any of aspects 23 through 27, further comprising: receiving the uplink data message from the UE on a random access channel in accordance with a random access procedure, wherein the communications procedure is the random access procedure.

Aspect 30: The method of aspect 29, further comprising: generating a set of measurements related to the random access procedure, wherein the set of measurements comprises a time difference between reception of a random access message and transmission of downlink data, a time difference between reception of the random access message and transmission of a second random access message, a payload size of the random access message, a payload size of the second random access message, or a combination thereof.

Aspect 31: The method of any of aspects 29 through 30, wherein receiving the report comprises: receiving a random access report from the UE based at least in part on successful reception of the uplink data message on the random access channel, wherein the one or more parameters included in the random access report comprise a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a random access channel fallback procedure during transmission of the uplink data message, or a combination thereof.

Aspect 32: The method of aspect 31, wherein receiving the random access report comprises: receiving the random access report from the UE based at least in part on successful reception of the uplink data message on the random access channel, wherein the one or more parameters included in the random access report comprise data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, non-access stratum event-triggering information associated with the communications procedure, timing information related to the uplink data message, or a combination thereof.

Aspect 33: The method of any of aspects 23 through 27, wherein receiving the report comprises: receiving a connection establishment failure report, a logged minimization of drive test report, or a small data transmission report from the UE based at least in part on unsuccessful reception of the uplink data message.

Aspect 34: The method of any of aspects 23 through 32, wherein receiving the report comprises: receiving a random access report, a logged minimization of drive test report, or a small data transmission report from the UE based at least in part on successful reception of the uplink data message.

Aspect 35: The method of any of aspects 23 through 27, wherein receiving the report comprises: receiving a connection establishment failure report from the UE based at least in part on unsuccessful reception of the uplink data message on a random access channel, wherein the one or more parameters included in the connection establishment failure report comprise a set of random access parameters related to the uplink data message, a set of channel measurements related to transmission of the uplink data message, data volume information pertaining to the UE, payload information associated with the uplink data message, data arrival information related to the uplink data message, or a combination thereof.

Aspect 36: The method of any of aspects 23 through 30, wherein receiving the report comprises: receiving a logged minimization of drive test report or a small data transmission report based at least in part on the communications procedure being a configured grant or on the communications procedure being a successful random access procedure, wherein the one or more parameters of the logged minimization of drive test report or the small data transmission report comprise a small data transmission type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, configured grant resource release information associated with the communications procedure, an indication of whether the UE has switched communications procedures during transmission of the uplink data message, cell reselection information related to the communications procedure, an indication of configured grant resources or dynamic grant resources used for transmission of the uplink data message, quality of service metrics associated with transmission of the uplink data message, or a combination thereof.

Aspect 37: The method of any of aspects 23 through 36, further comprising: receiving a small data transmission message as the uplink data message while the UE is in the inactive mode based at least in part on the uplink data message having a payload size that is below a preconfigured threshold.

Aspect 38: The method of any of aspects 23 through 37, wherein receiving the report comprises: receiving the report based at least in part on an attempt by the UE to transmit the uplink data message in an unlicensed radio frequency spectrum band, wherein the one or more parameters of the report comprise bandwidth part information related to transmission of the uplink data message, listen before talk failure information associated with transmission of the uplink data message, a failure status of the uplink data message, or a combination thereof.

Aspect 39: The method of any of aspects 23 through 38, wherein receiving the report comprises: receiving the report from the UE while the UE is in a connected mode or an inactive mode with respect to communications with the base station.

Aspect 40: The method of any of aspects 23 through 39, further comprising: receiving, from the UE, a capability message indicating a capability of the UE to generate self-organizing network or minimization of drive test reporting information for small data transmissions, wherein transmitting the control signaling to the UE is based at least in part on the capability message.

Aspect 41: The method of any of aspects 23 through 40, further comprising: transmitting a request for the report to the UE, wherein receiving the report from the UE is based at least in part on the request.

Aspect 42: The method of aspect 41, further comprising: receiving, from the UE, an indication that the report is available for transmission, wherein transmitting the request is based at least in part on receiving the indication.

Aspect 43: The method of any of aspects 23 through 42, further comprising: receiving the uplink data message, the report, an indication that the report is available for transmission, or a combination thereof via one or more signaling radio bearers or dedicated radio bearers in accordance with the set of self-organizing network or minimization of drive test reporting criteria.

Aspect 44: An apparatus for wireless communications at a UE, comprising a processor; memory coupled with the processor; and instructions stored in the memory and executable by the processor to cause the apparatus to perform a method of any of aspects 1 through 22.

Aspect 45: An apparatus for wireless communications at a UE, comprising at least one means for performing a method of any of aspects 1 through 22.

Aspect 46: A non-transitory computer-readable medium storing code for wireless communications at a UE, the code comprising instructions executable by a processor to perform a method of any of aspects 1 through 22.

Aspect 47: An apparatus for wireless communications at a base station, comprising a processor; memory coupled with the processor; and instructions stored in the memory and executable by the processor to cause the apparatus to perform a method of any of aspects 23 through 43.

Aspect 48: An apparatus for wireless communications at a base station, comprising at least one means for performing a method of any of aspects 23 through 43.

Aspect 49: A non-transitory computer-readable medium storing code for wireless communications at a base station, the code comprising instructions executable by a processor to perform a method of any of aspects 23 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor:
memory coupled with the processor; and
instructions stored in the memory and executable by the processor to cause the apparatus to:
transmit, in accordance with a communications procedure, an uplink data message to a base station while the UE is in an inactive mode with respect to communications with the base station:
generate a report that includes one or more parameters pertaining to uplink data message transmission to the base station, wherein the one or more parameters included in the report are based at least in part on the communications procedure associated with the uplink data message and on whether transmission of the uplink data message to the base station was successful; and
transmit the report to the base station.

2. The apparatus of claim 1, wherein the instructions to transmit the report are executable by the processor to cause the apparatus to:
transmit the report to the base station for enhancement of subsequent uplink data message transmissions from the UE, improvement of random access procedures and resources used for subsequent uplink data message transmissions from the UE, or both.

3. The apparatus of claim 1, wherein the instructions to transmit the uplink data message are executable by the processor to cause the apparatus to:
receive, from the base station, a configured grant indicating one or more physical uplink shared channel resources; and
transmit the uplink data message to the base station on the one or more physical uplink shared channel resources in accordance with the configured grant, wherein the communications procedure is the configured grant.

4. The apparatus of claim 1, wherein the instructions to transmit the uplink data message are executable by the processor to cause the apparatus to:
transmit the uplink data message to the base station on a random access channel in accordance with a random access procedure, wherein the communications procedure is the random access procedure.

5. The apparatus of claim 4, wherein the instructions to transmit the uplink data message on the random access channel are further executable by the processor to cause the apparatus to:
transmit the uplink data message via the random access channel based at least in part on a prior attempt to transmit the uplink data message to the base station in accordance with a configured grant being unsuccessful.

6. The apparatus of claim 4, wherein the instructions to generate the report are executable by the processor to cause the apparatus to:
generate a random access report based at least in part on successful transmission of the uplink data message on the random access channel, wherein the one or more parameters included in the random access report comprise a set of random access parameters used for transmission of the uplink data message, a preamble used for transmission of the uplink data message, a set of channel measurements pertaining to the communications procedure, data volume information pertaining to the UE, payload information related to the uplink data message, event-based logging information related to transmission of the uplink data message, an indication of a random access message used for transmission of the uplink data message, an indication of a random access purpose associated with the uplink data message, an indication of whether the UE has detected contention during the communications procedure, an indication of whether the UE has performed a random access channel fallback procedure during transmission of the uplink data message, or a combination thereof.

7. The apparatus of claim 6, wherein the instructions to generate the random access report are executable by the processor to cause the apparatus to:
generate the random access report based at least in part on successful transmission of the uplink data message on the random access channel, wherein the one or more parameters included in the random access report comprise data arrival information related to the uplink data message, radio bearer information associated with the uplink data message, network transmission type switching information associated with the communications procedure, timing information associated with a start of the communications procedure, an indication of whether the UE has switched communications procedures during transmission of the uplink data message, non-access stratum event-triggering information related to the communications procedure, timing information related to the uplink data message, or a combination thereof.

8. The apparatus of claim 6, wherein the instructions to generate the random access report are executable by the processor to cause the apparatus to:
log the one or more parameters of the random access report until a connection release message or a connection resume message is received from the base station.

9. The apparatus of claim 4, wherein the instructions to generate the report are executable by the processor to cause the apparatus to:
generate a logged minimization of drive test report or a small data transmission report based at least in part on successful transmission of the uplink data message on the random access channel.

10. The apparatus of claim 4, wherein the instructions are further executable by the processor to cause the apparatus to:
determine that transmission of the uplink data message on the random access channel was unsuccessful based at least in part on a failure of the random access procedure, expiration of a timer related to a failure status of the uplink data message, detection of an integrity check failure at the UE, or a combination thereof.

11. The apparatus of claim 10, wherein the instructions to generate the report are executable by the processor to cause the apparatus to:
generate a connection establishment failure report, a logged minimization of drive test report, or a small data transmission report based at least in part on failure of the transmission of the uplink data message on the random access channel.

12. The apparatus of claim 10, wherein the instructions to generate the report are executable by the processor to cause the apparatus to:
generate a connection establishment failure report based at least in part on determining that the transmission of the uplink data message on the random access channel was unsuccessful, wherein the connection establishment failure report comprises a set of random access parameters used for transmission of the uplink data message, a set of channel measurements related to transmission of the uplink data message, data volume information pertaining to the UE, payload information associated with the uplink data message, data arrival information related to transmission of the uplink data message, or a combination thereof.

13. The apparatus of claim 1, wherein the instructions to generate the report are executable by the processor to cause the apparatus to:
generate a logged minimization of drive test report or a small data transmission report based at least in part on the communications procedure being a configured grant or on the communications procedure being a successful random access procedure, wherein the one or more parameters of the logged minimization of drive test report or the small data transmission report comprise a small data transmission type used for transmission of the uplink data message, a set of channel measurements associated with transmission of the uplink data message, payload information related to the uplink data message, data volume information pertaining to the UE, event-based logging information related to transmission of the uplink data message, retransmission information associated with the uplink data message, data arrival information related to transmission of the uplink data message, radio bearer information associated with the uplink data message, timing information related to the uplink data message, traffic pattern information related to the uplink data message, configured grant resource release information associated with the communications procedure, an indication of whether the UE has switched communications procedures during transmission of the uplink data message, cell reselection information related to the communications procedure, an indication of configured grant resources or dynamic grant resources used for transmission of the uplink data message, quality of service metrics associated with transmission of the uplink data message, or a combination thereof.

14. The apparatus of claim 1, wherein the instructions to generate the report are executable by the processor to cause the apparatus to:
determine that a timer related to a failure status of the uplink data message has not expired; and
generate a logged minimization of drive test report or a small data transmission report based at least in part on determining that the timer has not expired, wherein the one or more parameters of the logged minimization of drive test report or the small data transmission report comprise a small data transmission type used for transmission of the uplink data message, event-based logging information related to transmission of the uplink data message, a set of channel measurements associated with transmission of the uplink data message, traffic pattern information related to the uplink data message, retransmission information associated with the uplink data message, data arrival information related to the uplink data message, radio bearer information related to the uplink data message, timing information associated with transmission of the uplink data message, non-access stratum event-triggering information pertaining to the communications procedure, network transmission type switching information associated with the communications procedure, or a combination thereof.

15. The apparatus of claim 1, wherein the instructions to generate the report are executable by the processor to cause the apparatus to:
determine that a timer related to a failure status of the uplink data message has expired; and
generate a logged minimization of drive test report or a small data transmission report based at least in part on determining that the timer has expired, wherein the one or more parameters of the logged minimization of drive test report or the small data transmission report comprise a small data transmission type used for transmission of the uplink data message, a set of channel measurements associated with transmission of the uplink data message, payload information related to the uplink data message, data volume information pertaining to the UE, event-based logging information related to transmission of the uplink data message, configured grant resource release information associated with the communications procedure, an indication of whether the UE has switched communications procedures during transmission of the uplink data message, cell reselection information related to the communications procedure, or a combination thereof.

16. The apparatus of claim 1, wherein the instructions to transmit the uplink data message are further executable by the processor to cause the apparatus to:
transmit a small data transmission message as the uplink data message while the UE is in the inactive mode based at least in part on the uplink data message having a payload size that is below a preconfigured threshold.

17. The apparatus of claim 1, wherein the instructions to generate the report are executable by the processor to cause the apparatus to:
generate the report based at least in part on transmitting the uplink data message in an unlicensed radio frequency spectrum band, wherein the one or more parameters of the report comprise bandwidth part information related to transmission of the uplink data message, listen before talk failure information associated with transmission of the uplink data message, a failure status of the uplink data message, or a combination thereof.

18. The apparatus of claim 1, wherein the instructions to transmit the report are executable by the processor to cause the apparatus to:
transmit the report to the base station while the UE is in a connected mode or an inactive mode with respect to communications with the base station.

19. The apparatus of claim 1, wherein the instructions are further executable by the processor to cause the apparatus to:
transmit, to the base station, a capability message indicating a capability of the UE to generate self-organizing network or minimization of drive test reporting information for small data transmissions; and
receive, from the base station and based at least in part on the capability message, control signaling that indicates a set of self-organizing network or minimization of drive test reporting criteria, wherein generating the report is based at least in part on the set of self-organizing network or minimization of drive test reporting criteria.

20. The apparatus of claim 1, wherein the instructions are further executable by the processor to cause the apparatus to:
transmit, to the base station and based at least in part on generating the report, an indication that the report is available for transmission.

21. The apparatus of claim 20, wherein the instructions are further executable by the processor to cause the apparatus to:
receive, from the base station and in response to the indication, a request for the UE to transmit the report, wherein transmitting the report is based at least in part on receiving the request.

22. The apparatus of claim 1, wherein the instructions are further executable by the processor to cause the apparatus to:
transmit the uplink data message, the report, an indication that the report is available for transmission, or a combination thereof via one or more signaling radio bearers or dedicated radio bearers.

23. A method for wireless communications at a user equipment (UE), comprising:
transmitting, in accordance with a communications procedure, an uplink data message to a base station while the UE is in an inactive mode with respect to communications with the base station;
generating a report that includes one or more parameters pertaining to uplink data message transmission to the base station, wherein the one or more parameters included in the report are based at least in part on the communications procedure associated with the uplink data message and on whether transmission of the uplink data message to the base station was successful; and
transmitting the report to the base station.

24. The method of claim 23, wherein transmitting the report comprises:
transmitting the report to the base station for enhancement of subsequent uplink data message transmissions from the UE, improvement of random access procedures and resources used for subsequent uplink data message transmissions from the UE, or both.

25. The method of claim 23, wherein transmitting the uplink data message comprises:
receiving, from the base station, a configured grant indicating one or more physical uplink shared channel resources; and
transmitting the uplink data message to the base station on the one or more physical uplink shared channel resources in accordance with the configured grant, wherein the communications procedure is the configured grant.

26. The method of claim 23, wherein transmitting the uplink data message comprises:
transmitting the uplink data message to the base station on a random access channel in accordance with a random access procedure, wherein the communications procedure is the random access procedure.

27. The method of claim 26, further comprising:
determining that transmission of the uplink data message on the random access channel was unsuccessful based at least in part on a failure of the random access procedure, expiration of a timer related to a failure status of the uplink data message, detection of an integrity check failure at the UE, or a combination thereof.

28. The method of claim 23, further comprising:
transmitting, to the base station, a capability message indicating a capability of the UE to generate self-organizing network or minimization of drive test reporting information for small data transmissions; and
receiving, from the base station and based at least in part on the capability message, control signaling that indicates a set of self-organizing network or minimization of drive test reporting criteria, wherein generating the report is based at least in part on the set of self-organizing network or minimization of drive test reporting criteria.

29. An apparatus for wireless communications at a user equipment (UE), comprising:
means for transmitting, in accordance with a communications procedure, an uplink data message to a base station while the UE is in an inactive mode with respect to communications with the base station:
means for generating a report that includes one or more parameters pertaining to uplink data message transmission to the base station, wherein the one or more parameters included in the report are based at least in part on the communications procedure associated with the uplink data message and on whether transmission of the uplink data message to the base station was successful; and
means for transmitting the report to the base station.

30. A non-transitory computer-readable medium storing code for wireless communications at a user equipment (UE), the code comprising instructions executable by a processor to:
transmit, in accordance with a communications procedure, an uplink data message to a base station while the UE is in an inactive mode with respect to communications with the base station;
generate a report that includes one or more parameters pertaining to uplink data message transmission to the base station, wherein the one or more parameters included in the report are based at least in part on the communications procedure associated with the uplink data message and on whether transmission of the uplink data message to the base station was successful; and
transmit the report to the base station.
